(19) United States
(12) Patent Application Publication
(10) Pub. No.: US 2010/0177101 A1
(43) Pub. Date: Jul. 15, 2010

(54) CONSTELLATION GRAPH RECORD DISPLAY DEVICE AND ITS METHOD

(75) Inventor: Mayumi Higa, Hyogo (JP)

Correspondence Address: Jason H. Vick;Sheridan Ross, PC, Suite # 1200, 1560 Broadway, Denver, CO, 80202, US

(73) Assignees: CHAOS TECHNOLOGY RESEARCH LABORATORY, Hyogo (JP); HITACHI SYSTEMS & SERVICES, LTD., Tokyo (JP)

(21) Appl. No.: 12/669,540

(22) PCT Filed: Jul. 22, 2008
(86) PCT No.: PCT/JP2008/063141

§ 371 Date: Feb. 10, 2010

(30) Foreign Application Priority Data
Jul. 20, 2007 (JP) 2007-189549

(51) Int. Cl. G06T 11/20

(52) U.S. Cl. 345/440

(57) ABSTRACT

Septuplicate concentric semi circles are defined (S103). An intersection pk of kth straight line and kth circle is calculated (step S107). A point p (k−1) and a point are connected with a line segment (S109). In this case, a point p0 and a p1 are connected with a line segment because K=1. It is judged whether the processing number k is the final (S111). If is not the final, the processing number k is incremented (S113), and repeats the processing after Step S107. Time-series data can be displayed so as to clearly distinguish variations without varying the angle(s).

### TECHNICAL FIELD

The present invention relates to a constellation graph, more specifically to a display method of chronological data.

### BACKGROUND ART

The patent document 1 discloses a computer system for measuring psychological immunity such as communication capabilities and the degree of dementia by carrying out chaos analysis to the acquired biological information. Specifically, it is disclosed that the data to which chaos analysis being performed is used for calculation as vectors having the same length and such vectors are displayed in a constellation graph (see FIGS. 29 and 30 of Patent document 1).

Patent document 1: Japanese patent laid-open publication No. 2006-204502

### DISCLOSURE OF THE INVENTION

### Problem to be Solved by the Invention

However, there exists the following problems in the case of connecting the vectors having the same length. A substantial number of measurements are required to reach the trajectory of the vectors up until on the circumference of the constellation graph. Especially, the trajectory is able to quickly reach on the circumference without carrying out substantial number of measurements in the case of less variations are observed on angles θ with respect to the measurement result, but the trajectory does not readily reach on the circumference in the case of more variations are observed. Of course, a method of normalizing so that the distance from the origin becomes the radius of a constellation graph may consider, but the method against the basic idea of a constellation graph, because angles θ need to be changed in such case.

It is an object of the present invention to provide a device capable of intelligibly displaying history of chronological data on a constellation graph.

The characteristics, usage(s), advantage(s) of the present invention will be apparent from the embodiments herein and appended figures.

### Means for Solving the Problem

1. The history display system according to the present invention is a history display system for displaying history of data to be displayed in a constellation graph by displaying a line segment from a center of an arc to a specific position on the arc with an angle corresponding to a value of the data to be displayed, the system comprising: 1) storage means for storing plural data to be displayed in chronological order; 2) arc definition means for defining a predetermined number of concentric arcs being enlarges for a predetermined interval from a reference arc having a predetermined diameter; 3) straight line definition means for defining plural straight lines passing through a center of the reference arc and with angles corresponding to the data to be displayed in ascending order by reading out the plural number of data to be displayed from the storage means in chronological ascending order; 4) intersection calculation means for calculating plural number of intersections for a straight line of a pth order out of the defined ascending straight lines and a concentric arc of the pth order from the reference arc while varying the number representing the order p; and 5) connection display means for connecting the plural intersections calculated by the intersection calculation means with a line segment in chronological order and displaying the line segment; 6) wherein the data to be displayed is respectively constructed of data for plural measurement results, 7) wherein the straight line definition means defines two straight lines for representing variations so that the previously defined straight line is located between the two straight line, the angles of two straight lines become larger when the degree of variations being calculated become larger while defining angle of the straight line from an average value of the data for plural measurement results with respect to each of the data to be displayed, 8) wherein the system further comprises variation representation circle definition means for calculating an intersection of a second reference arc having a radius of a predetermined ratio of the reference arc and the straight line defining two straight lines for representing variations with respect to each of the data to be displayed and for defining a circle representing variation defined in accordance with the intersection of the arc and the straight line, and 9) wherein the connection display means displays a circle representing variation defined by the variation representation circle definition means on a corresponding intersection.

In this way, the data to be displayed arranged in chronological order can be displayed in a constellation graph without varying angle(s). Variation(s) of the data to be displayed is displayed therewith.

2. The history display device according to the present invention is a history display system for displaying history of data to be displayed in a constellation graph by displaying a line segment from a center of an arc to a specific position on the arc with an angle corresponding to a value of the data to be displayed, the system comprising: 1) storage means for storing plural data to be displayed in chronological order; 2) arc definition means for defining a predetermined number of concentric arcs each having a larger diameter than that of adjacent arc for a predetermined interval from a reference arc having a predetermined diameter; 3) first intersection calculation means for calculating an intersection of a straight line and the reference arc by reading out a first ranked data to be displayed in chronological ascending order out of the plural data to be displayed, wherein the straight line pass through the center of the reference arc and is defined with an angle corresponding to each of data to be displayed; 4) subsequently ranked intersection calculation means for calculating another intersection with another arc having a subsequently larger diameter than the arc used to calculate the intersection as a subsequently ranked intersection by reading out subsequently ranked data to be displayed to the data used for calculating most recently calculated intersection, wherein the another intersection pass through the most recently calculated intersection, and wherein the calculation means repeatedly calculates the subsequently ranked intersection; and 5) connection display means for connecting the intersection calculated by the first intersection calculation means from the center of the reference arc and the plural subsequently ranked intersections calculated by the subsequent order intersection calculation means with a line segment in chronological order and for displaying the line segment.

In this way, the data to be displayed arranged in chronological order can be displayed in a constellation graph without varying angle(s).

3. The history display device according to the present invention is a history display device for displaying history of data to be displayed in a constellation graph by displaying a line segment from a center of an arc to a specific position on the arc with an angle corresponding to a value of the data to be displayed, the device comprising: 1) arc definition means for defining a predetermined number of concentric arcs each having a diameter varying in a predetermined interval from a reference arc having a predetermined diameter; 2) straight line definition means for defining plural straight lines passing through a center of the reference arc with angles corresponding to the data to be displayed in chronological order when plural data to be displayed is provided; 3) intersection calculation means for calculating an intersection for a straight line of a pth order out of the plural straight lines and a concentric arc of a pth order from the reference arc when the number of rank order p is provided; 4) repeat means for providing plural rank orders to the intersection calculation means while varying the number of rank order p; and

connection display means for connecting the plural intersections calculated with the line segment in chronological order and for displaying the line segment.

In this way, the data to be displayed arranged in chronological order can be displayed in a constellation graph without varying angle(s).

4. The history display device according to the present invention is a history display device for displaying history of data to be displayed in a constellation graph by displaying a line segment from a center of an arc to a specific position on the arc with an angle corresponding to a value of the data to be displayed, the device comprising: 1) storage means for storing plural data to be displayed in chronological order; 2) arc definition means for defining a predetermined number of concentric arcs each having a diameter varying in a predetermined interval from a reference arc having a predetermined diameter; 3) first intersection calculation means for calculating an intersection of a straight line and the reference arc by reading out a first ranked data to be displayed in chronological ascending order out of the plural data to be displayed, wherein the straight line pass through the center of the reference arc and is defined with an angle corresponding to the data to be displayed; 4) subsequently ranked intersection calculation means for calculating another intersection with another arc having a subsequently larger diameter than the arc used to calculate the intersection as a subsequently ranked intersection by reading out subsequently ranked data to be displayed to the data used for calculating most recently calculated intersection, wherein the another intersection pass through the most recently calculated intersection, and wherein the calculation means repeatedly calculates the subsequently ranked intersection; 5) repeat calculation means for making the subsequently ranked intersection calculation means to further calculate subsequently ranked intersections repeatedly; and 6) connection display means for connecting the intersection calculated by the first intersection calculation means from the center of the reference arc and the plural subsequently ranked intersections calculated by the subsequent order intersection calculation means with a line segment in chronological order and for displaying the line segment.

In this way, the data to be displayed arranged in chronological order can be displayed in a constellation graph without varying angle(s).

5. In the history display device according to the present invention, wherein the connection display means also display the arcs used to calculate the intersections the connection display means also display the arcs used to calculate the intersections. In this way, the arc(s) which become the ground of the calculation can also be displayed.

6. In the history display device according to the present invention, the device comprising: 1) detection means for detecting each of the data to be displayed from a user; and 2) entry means for entering self-judgment data of the user at that time when the data to be displayed is detected; 3) and wherein the connection display means also displays the self-judgment data together with the line segment connected in chronological order. In this way, analysis of the history data can be carried out with reference to the self-judgment data of the user.

7. The history display data generation device according to the present invention is a device for generating data displaying history of data to be displayed in a constellation graph by displaying a line segment from a center of an arc to a specific position on the arc with an angle corresponding to a value of the data to be displayed, the device comprising: 1) arc definition means for defining a predetermined number of concentric arcs each having a diameter varying in a predetermined interval from a reference arc having a predetermined diameter; 2) straight line definition means for defining plural straight lines passing through a center of the reference arc with angles, corresponding to the data to be displayed in chronological order when plural data to be displayed is provided; 3) intersection calculation means for calculating an intersection for a straight line of a pth order out of the plural straight lines and a concentric arc of a pth order from the reference arc when the number of rank order p is provided; 4) repeat means for providing plural rank orders to the intersection calculation means while varying the number of rank order p; and 5) connection display means for connecting the plural intersections calculated with the line segment in chronological order and for displaying the line segment.

In this way, the data to be displayed arranged in chronological order can be displayed in a constellation graph without varying angle(s).

8. The history display data generation device according to the present invention is a device for generating history data of data to be displayed in a constellation graph by displaying a line segment from a center of an arc to a specific position on the arc with an angle corresponding to a value of the data to be displayed, the device comprising: 1) arc definition means for defining a predetermined number of concentric arcs each having diameter vary in a predetermined interval from a reference arc having a predetermined diameter; 2) first intersection calculation means for calculating an intersection of a straight line and the reference arc by reading out a first ranked data to be displayed in chronological ascending order out of the plural data to be displayed when plural data to be displayed is provided in chronological order, wherein the straight line pass through the center of the reference arc and is defined with an angle corresponding to the data to be displayed; 3) subsequently ranked intersection calculation means for calculating another intersection with another arc having a subsequently larger diameter than the arc used to calculate the intersection as a subsequently ranked intersection by reading out subsequently ranked data to be displayed to the data used for calculating most recently calculated intersection, wherein the another intersection passing through the most recently calculated intersection, and wherein the calculation means repeatedly calculates the subsequently ranked intersection; 4) repeat calculation means for making the subsequently ranked intersection calculation means to further calculate subsequently ranked intersections repeatedly; and 5) generation means for generating history data of connecting from the center of the reference arc, the intersection calculated by the first intersection calculation means and the plural subsequently ranked intersections calculated by the subsequent order intersection calculation means with a line segment in chronological order and for displaying the line segment.

In this way, the data to be displayed arranged in chronological order can be displayed in a constellation graph without varying angle(s).

9. The history display data generation device according to the present invention comprising:

communication means for carrying out communication with a computer terminal to be network-connected;

and wherein the communication means transmits the generated history data to the computer terminal

10. The program according to the present invention is a program for executing a computer to function as a device for generating data displaying history of data to be displayed in a constellation graph by displaying a line segment from a center of an arc to a specific position on the arc with an angle corresponding to a value of the data to be displayed, the device comprising: 1) arc definition means for defining a predetermined number of concentric arcs each having diameter vary in a predetermined interval from a reference arc having a predetermined diameter; 2) straight line definition means for defining plural straight lines passing through a center of the reference arc with angles corresponding to the data to be displayed in chronological order when plural data to be displayed is provided; 3) intersection calculation means for calculating an intersection for a straight line of a pth order out of the plural straight lines and a concentric arc of a pth order from the reference arc when the number of rank order p is provided; 4) repeat means for providing plural rank orders to the intersection calculation means while varying the number of rank order p; and 5) connection display means for connecting the plural intersections calculated with the line segment in chronological order and for displaying the line segment.

In this way, the data to be displayed arranged in chronological order can be displayed in a constellation graph without varying angle(s).

11. The program according to the present invention is A program for executing a computer to function as a device for generating history data of data to be displayed in a constellation graph by displaying a line segment from a center of an arc to a specific position on the arc with an angle corresponding to a value of the data to be displayed, the device comprising: 1) arc definition means for defining a predetermined number of concentric arcs each having diameter vary in a predetermined interval from a reference arc having a predetermined diameter; 2) first intersection calculation means for calculating an intersection of a straight line and the reference arc by reading out a first ranked data to be displayed in chronological ascending order out of the plural data to be displayed when plural data to be displayed is provided in chronological order, wherein the straight line pass through the center of the reference arc and is defined with an angle corresponding to the data to be displayed; 3) subsequently ranked intersection calculation means for calculating another intersection with another arc having a subsequently larger diameter than the arc used to calculate the intersection as a subsequently ranked intersection by reading out subsequently ranked data to be displayed to the data used for calculating most recently calculated intersection, wherein the another intersection pass through the most recently calculated intersection, and wherein the calculation means repeatedly calculates the subsequently ranked intersection; 4) repeat calculation means for making the subsequently ranked intersection calculation means to further calculate subsequently ranked intersections repeatedly; and 5) generation means for generating history data connecting the intersection calculated by the first intersection calculation means from the center of the reference arc and the plural subsequently ranked intersections calculated by the subsequent order intersection calculation means with a line segment in chronological order.

In this way, the data to be displayed arranged in chronological order can be displayed in a constellation graph without varying angle(s).

The term “biological information” means information representing life activities of creatures such as human. Fingertip pulse waves correspond to such term in the embodiments.

The term “psychological immunity” is a concept including the capability to adapt to his/her external environment and intellectual functions. The term “straight lines representing variations” corresponds to lines Mn, Mn (see FIG. 44) in the embodiments. The term “arc for determining variation” corresponds to arc Cb in the embodiments. Standard deviation is used as the term “the degree of variations” in the embodiments, but it is limited to that parameter, any other parameter(s) capable of defining variation(s) may also be used. The term “circles representing variations” corresponds to a circle Cbk in the embodiments. Further, in the embodiments, the circle Cbk is defined as a circle passing through an intersection of the two straight lines Mm Mn and the arc Cb around an intersection Pkb. The circle Cbk passes through the intersections of the arc cb for determining variation and the two lines and its origin being pkb is defined. The circle Cbk moves to an intersection Pk with an arc corresponding to chronological order of the line Lk and is displayed. In this way, variation on the line Lk can be displayed on the intersection Pk. For example, when K equal six, the arc is displayed on the point P6 as shown in FIG. 44.

The term “program” is not only a program(s) directly executable by CPU, but it is also a concept including a program(s) in the source format, a compressed program(s), an encrypted program(s) and the like.

### BRIEF DESCRIPTION OF DRAWINGS

FIG. 1 is an external view of a mouse according to an embodiment of the present invention.

FIG. 2 is another external view of the mouse according to an embodiment of the present invention.

FIG. 3a is a cross-section diagram of the mouse 2.

FIG. 3b is a detailed diagram of a light-emitting element 14.

FIG. 3c is a diagram showing a positional relationship between the light-emitting element 14 and a light-receiving element 16.

FIG. 4 is a circuit block diagram of the mouse 2.

FIG. 5 is a functional block diagram of a system using a mouse according to an embodiment of the invention.

FIG. 6 is hardware structure realizing a device for judging psychological immunity shown in FIG. 5 using a CPU.

FIG. 7 shows examples of fingertip pulse waves measured by the mouse 2.

FIG. 8 is a flowchart of another analysis program.

FIG. 9 is another flowchart of the analysis program.

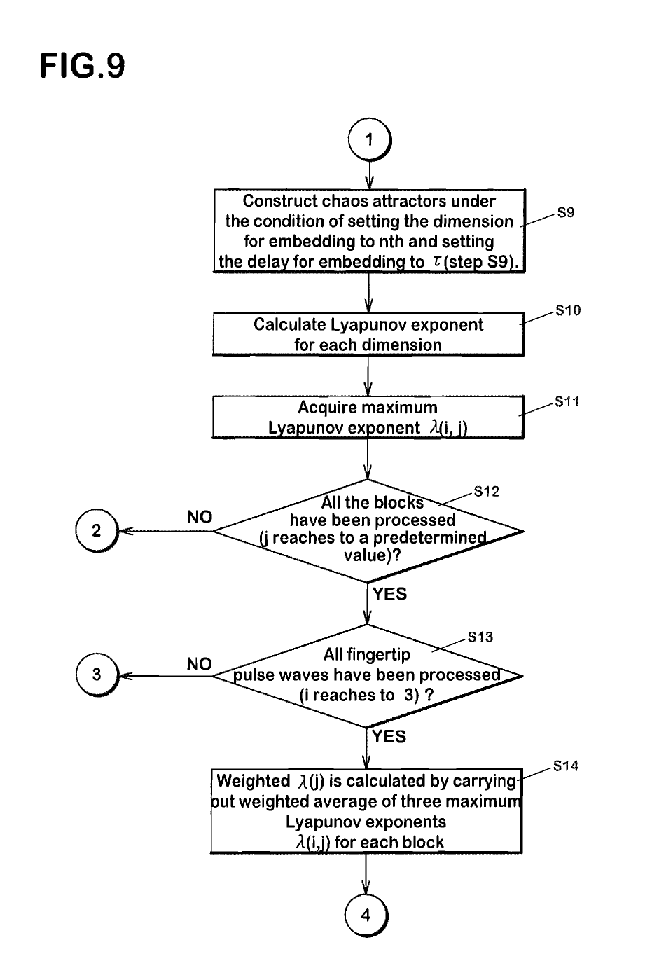

FIG. 10 is another flowchart of the analysis program.

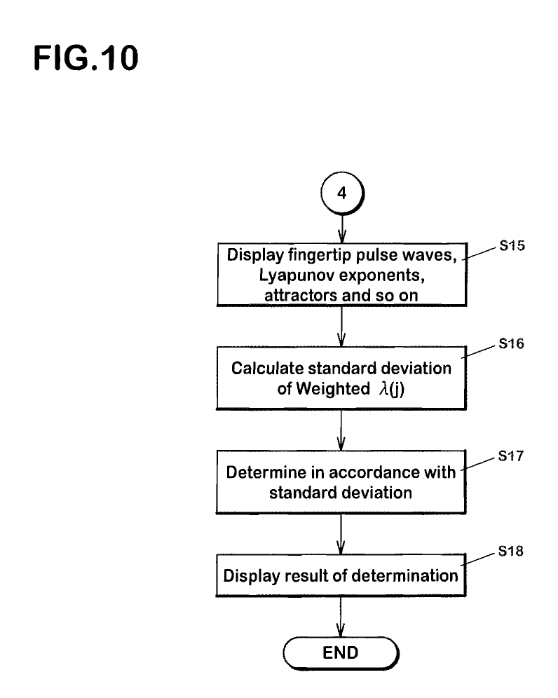

FIGS. 11A through 11C are examples of fingertip pulse waves measured from the first measurement to the third measurement.

FIGS. 12A through 12C are diagrams showing processing of constructing attractors.

FIG. 13 is a display screen on which fingertip pulse waves, Lyapunov exponents, attractors in chronological order and so on are displayed.

FIG. 14 is another display screen on which fingertip pulse waves, Lyapunov exponents, attractors in chronological order and so on are displayed.

FIG. 15 is a diagram showing an example of a communication capability table.

FIG. 16 is a diagram showing an example of a table illustrating the degree of dementia.

FIG. 17 shows results of experiments and research of the relationship between standard deviations of Lyapunov exponents and communication capabilities.

FIG. 18 shows another result of experiments and research of the relationship between standard deviations of Lyapunov exponents and communication capabilities.

FIG. 19 shows organized data of the data shown in FIGS. 17 and 18.

FIG. 20 shows results of experiments and research of the relationship between standard deviations of Lyapunov exponents and communication capabilities.

FIG. 21 shows another result of experiments and research of the relationship between standard deviations of Lyapunov exponents and communication capabilities.

FIG. 22 shows organized data of the data shown in FIGS. 20 and 21.

FIG. 23 is a diagram for describing process for drawing a constellation graph.

FIG. 24 is an example of the constellation graph.

FIG. 25 is another example of the constellation graph.

FIG. 26 is a functional block diagram of the system constructed by another example.

FIG. 27 is a configuration example of the system of FIG. 26.

FIG. 28 is a hardware structure of a computer 28.

FIG. 29 is a hardware structure of a server device 60.

FIG. 30 is a flowchart showing processing performed by the computer 28 and the server device 60.

FIG. 31 is another flowchart showing processing performed by the computer 28 and the server device 60.

FIG. 32 is an example of a constellation graph.

FIG. 33 is another example of the constellation graph.

FIG. 34 is an external view of a mouse according to an embodiment of the present invention.

FIG. 35 is another external view of the mouse according to an embodiment of the present invention.

FIG. 36 is a cross-section diagram of the mouse 2.

FIG. 37 is a functional block diagram of a history display system 100.

FIG. 38 is a flowchart of surface processing.

FIG. 39 is a diagram illustrating a status under which reference arcs C1 through an arc C7 are defined.

FIG. 40 is an example of a constellation graph.

FIG. 41 is another example of the constellation graph.

FIG. 42 is a diagram showing icons used for self-judgment entry carried out by the user.

FIG. 43 is another example of the constellation graph.

FIG. 44 is a diagram for illustrating how to display variations on a constellation graph.

FIG. 45 is a diagram illustrating a constellation graph on which variations are displayed.

### DESCRIPTION OF REFERENCE NUMERALS

2: mouse
10: recess part
12: window

### EMBODIMENTS FOR CARRYING OUT THE INVENTION

### 1. An Embodiment to be a Background

### First Embodiment

### 1. Structure of a Mouse

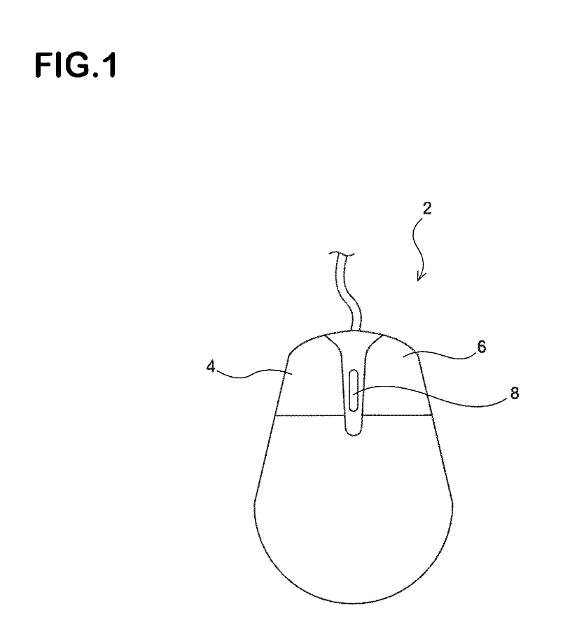

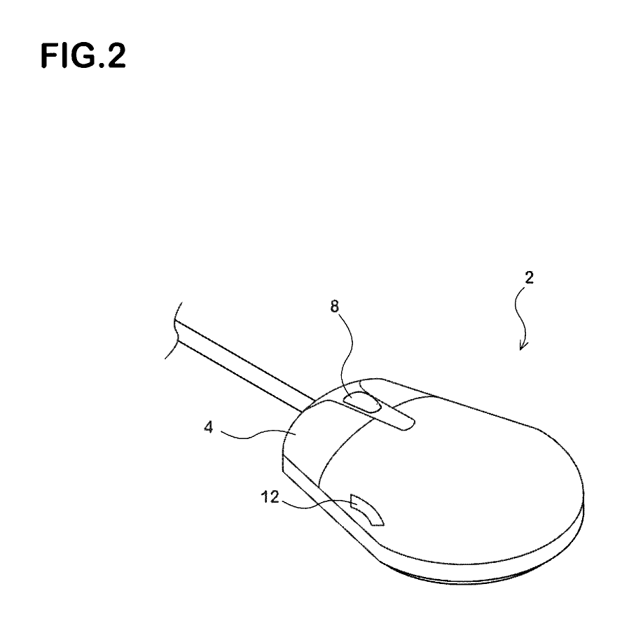

FIGS. 1 and 2 show external views of the mouse 2 that work as an entry device of an embodiment according to the present invention. The mouse 2 comprises click buttons 4, 6 on the fore-end of its body. And it also comprises a scroll wheel 8. An optical or mechanical movement detection sensor(s) is installed (not shown) in the reverse side of the body.

FIG. 2 is a diagram to be viewed from a side. As shown in the figure, a window 12 made of an infrared-transparent material is provided on the side part thereof. The window 12 is provided at a position so that the fore-end of the thumb is located on the window during the use of the mouse 2.

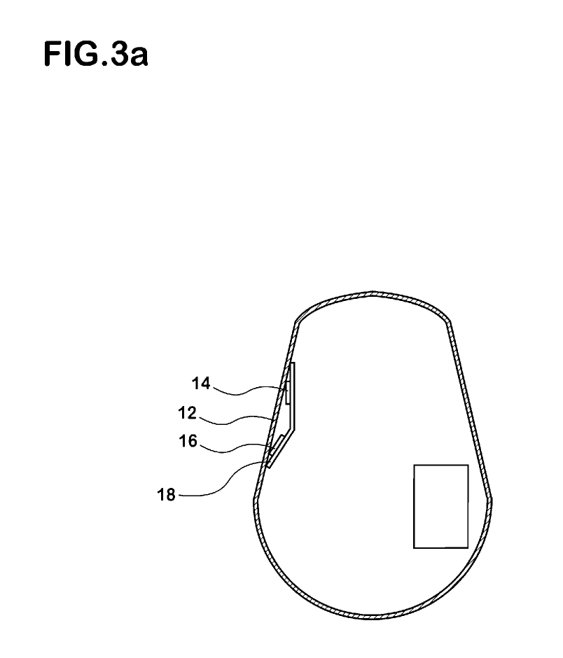

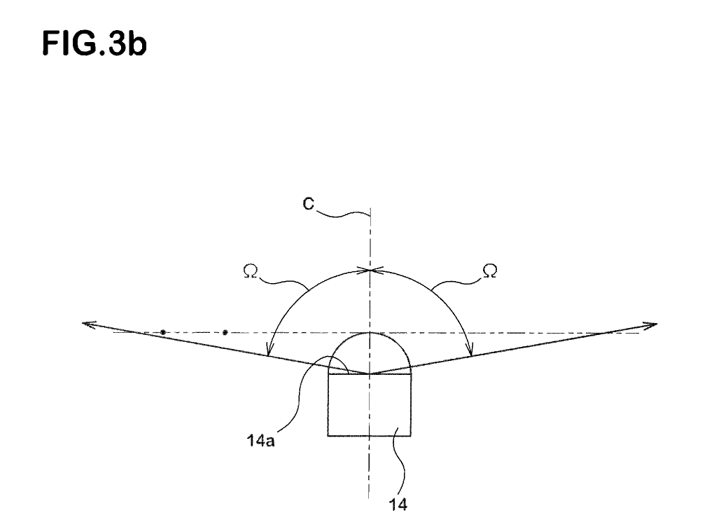

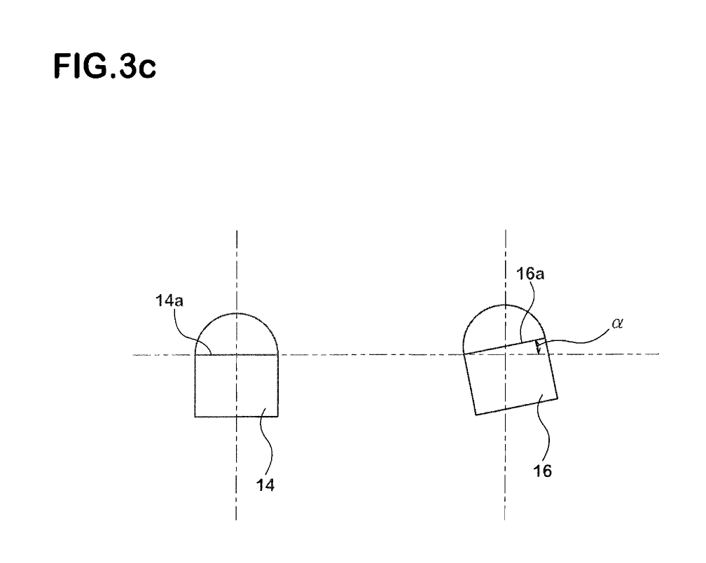

FIG. 3a shows a plane section of the mouse 2. A light-emitting element (near infrared rays) 14 is provided toward the window 12. Similarly, a light-receiving element (near infrared rays) 16 is provided toward the window 12. Both the light-emitting element and the light-receiving element 16 are fixed to a base 15.

During the use of the mouse 2, the thumb of the user covers the window 12. Thus, the near infrared rays from the light-emitting element 14 passing through the window 12 and are reflected on blood vessels inside the thumb and then again pass through the window to receive the rays on the light-receiving element 16. The amount of rays received varies depends on the blood flow rate of the blood vessels. In other words, pulse wave outputs are obtained from the light-receiving element.

FIG. 3b shows detailed of the light-emitting element 14. The light-emitting element 14 emits near infrared rays from a light-emitting surface 14a. The emitted rays are emitted with emission angle of Ω from the central axis C as shown in the figure. When high acutance and low accuracy measurement (higher priority is given to quickness than accuracy) is carried out, it is preferred to set the emission angle Ω in a range of 42 to 90 degrees. More preferably, such angle is in the range of 70 to 80 degrees.

On the other hand, when low acutance and high accuracy measurement (higher priority is given to accuracy than quickness) is carried out, it is preferred to set the emission angle Ω in a range of 4 to 52 degrees. More preferably, such angle is in the range of 20 to 30 degrees.

When the low acutance and high accuracy measurement is carried out, the light-emitting surface 14a of the light-emitting element 14 and a light-receiving surface 16a of the light-receiving element 16 are preferred to have an angle of α rather than horizontal with each other as shown in FIG. 3C. This angle α is preferred to a range of 2 to 57 degrees. This is because most of the rays from the light-emitting element 14 can not be received with the receiving side. When high acutance and low accuracy measurement is carried out, the angle α may be 0 degree (i.e. parallel).

When the angle α is in a range of 42 to 52 degrees, a well-balanced measurement with respect to both acutance and the curacy can be carried out.

Regardless of either high acutance and low accuracy or low acutance and high accuracy measurement, the receiving angle Ω is preferably lower. In this embodiment, only the light from a direction (substantially) perpendicular to the light-receiving surface is received. This is because if the receiving angle Ω becomes too wide, too much influence(s) from noise is received.

In this embodiment, since the window 12 is provided on a position so that the thumb supposed to be thereon, the window 12 is always closed by the thumb, thereby accurate measurement can be performed as a result of less influence(s) from ambient light.

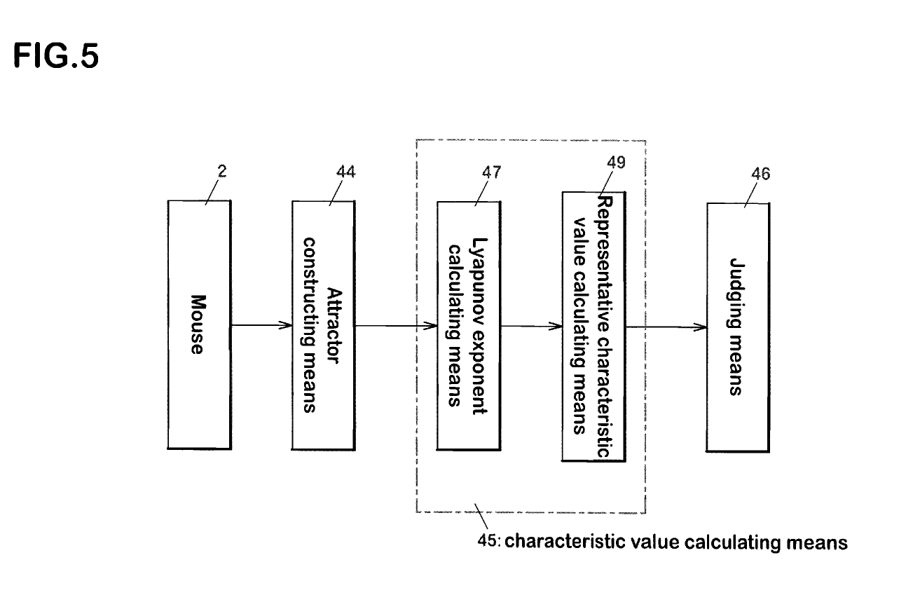

FIG. 4 is a circuit block diagram of the mouse 2. A light-receiving element 16 is provided correspondently with the light-receiving element 14. Pulse wave output of the light-receiving element 16 is supplied to a filter 20 after amplification thereof by an amplifier 18. In this embodiment, the pulse waves having frequencies of 0.098 Hz through 20.2 Hz pass through a filter and other components thereof are cut. In this way, influences from noise are restricted.

The output of the filter 20 is converted into digital signals by an A/D converter 22. A CPU 24 outputs pulse wave digital signals to an USB connector 28 via an USB interface 26. The pulse wave digital signals can be sent to a computer because the USB connector 28 is connected to the computer.

The output of an optical sensor 32 provided on the backside of the body for detecting the amount of transfer of the body of the mouse 2 is supplied to a rotation detecting circuit 34. The rotation of the scroll wheel 8 is detected by the rotation detecting circuit 34. A switch 36 detects the press of the buttons 4 and 6.

The CPU 24 outputs to the USB connector 28 via the USB interface 26 the output of a travel distance detecting circuit 30, that of the rotation detecting circuit 34 and of switch 36 together.

The USB interface 26 packetizes each of the received data and send it out in chronological order.

Although, the light-emitting element and the light receiving element are provided at positions corresponding to thumb in this embodiment, these elements may also be provided at positions corresponding to another finger.

Alternatively, pulse wave signals may be acquired from plural fingers. The CPU 24 may also output a plurality of pulse wave signals from the USB connector 28 respectively, or may output an averaged signal. Alternatively, it is possible to select a signal having the largest amplitude out of a plurality of pulse wave signals and output the selected signal.

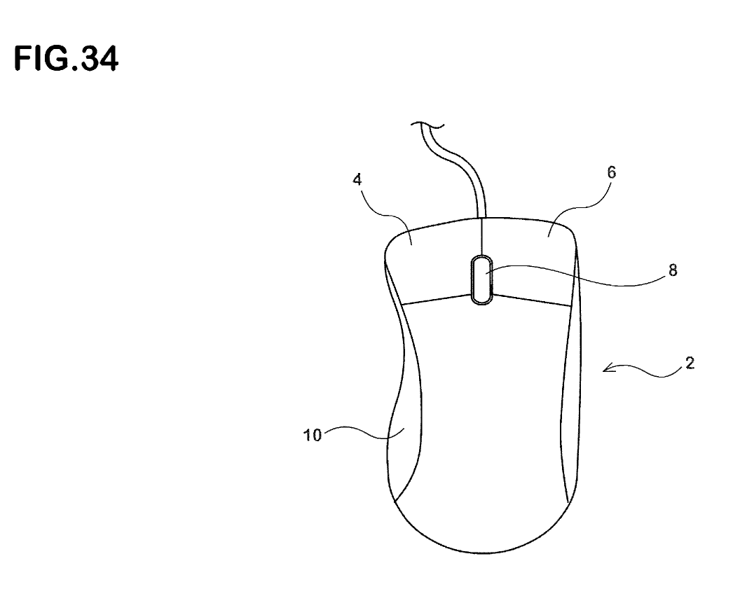

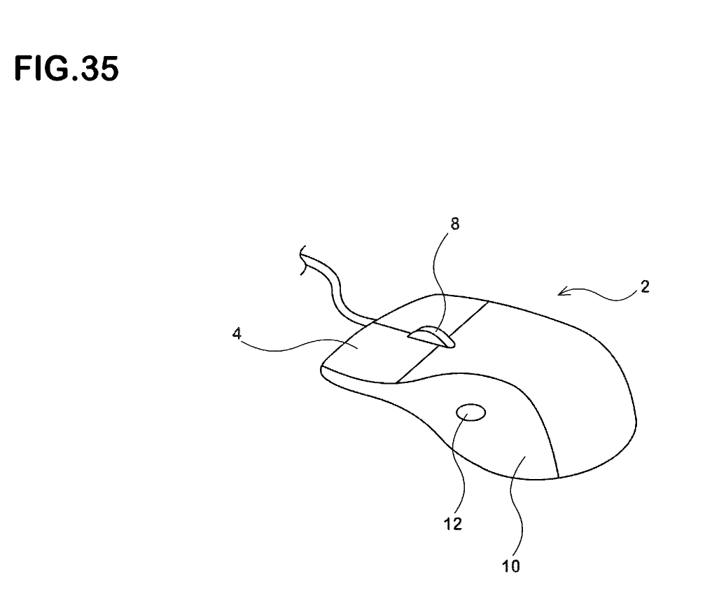

FIGS. 34 and 35 show external views of the mouse in another embodiment. In this embodiment, a recess 10 is provided on the side part thereof so that it suits the shape of the thumb. By providing the recess 10, the mouse can easily be hold with the fingers.

FIG. 35 is a diagram of the recess 10 viewed from a side. Another window 12 made of an infrared-transmissive material for the infrared sensors is provided into the recess 10. This window 12 is provided on a part where the forefront of the thumb is located during the used of the mouse 2.

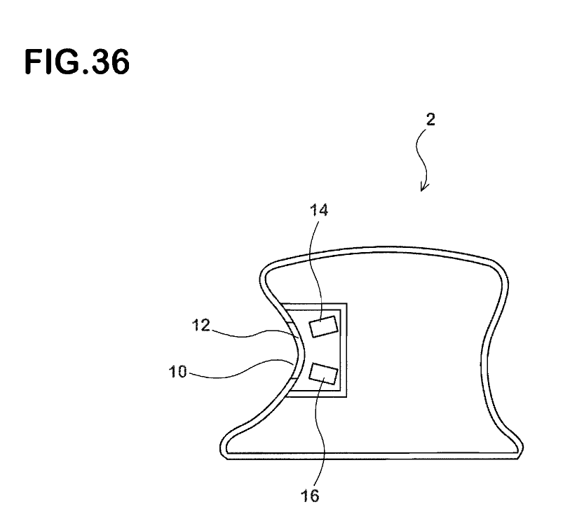

FIG. 36 shows a cross section of the vicinity of the window 12. A light-emitting element (infrared) 14 is provided toward the window 12. A light-receiving element (infrared) 16 is provided toward the window 12 as well. The window 12 is covered with the thumb of the user during the use of the mouse. Because the window 12 provided on the recess 10 is always closed by the thumb, thereby accurate measurement can be performed under less influence(s) from ambient light. The layout of the light-emitting element 14 and the light-receiving element 16 may be arranged similar to that shown in FIG. 1.

Although, the light-emitting element and the light receiving element are provided at positions corresponding to thumb in this embodiment, these elements may be provided at positions corresponding to another finger. At that time, it is preferred to provide the recess part corresponding to such finger.

### 2. Example of System Structure

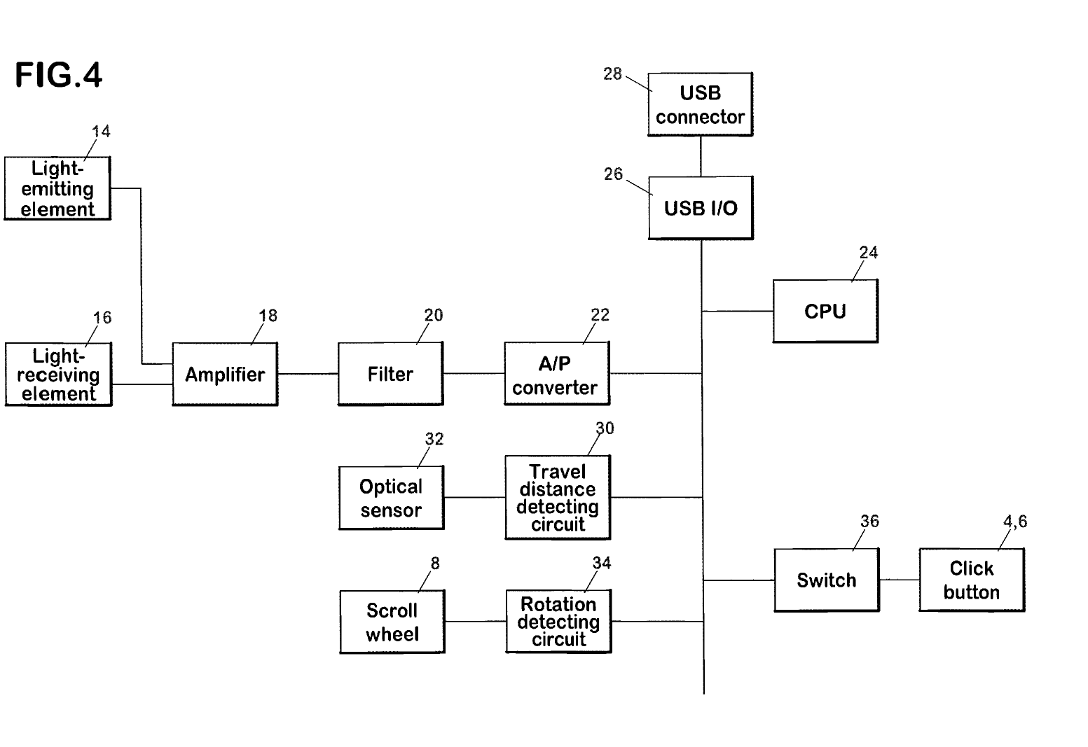

FIG. 5 shows a functional block diagram of a device for judging psychological immunity (degree of health) by an embodiment that becomes a background art of the present invention. The mouse 2 acquires information on blood flow (pulse wave information) of an object person. Attractor constructing means 44 constructs nth dimension chaotic attractors according to the acquired information on blood flow. Lyapunov exponent calculating means 47 calculates Lyapunov exponent according to the nth chaotic attractors and calculates representative chaotic attractors representing Lyapunov exponent in each dimension. Representative characteristic value calculating means 49 calculates a characteristic value of the Lyapunov exponent according to the representative Lyapunov exponent in chronological order. Judging means 46 judges the degree of psychological immunity of the object person according to biological information of the object person. In this way, the degree of psychological immunity of the object person can be judged according to the biological information of the object person. In this embodiment, characteristic value calculating means 45 is constructed by the Lyapunov exponent calculating means 47 and the representative characteristic value calculating means 49.

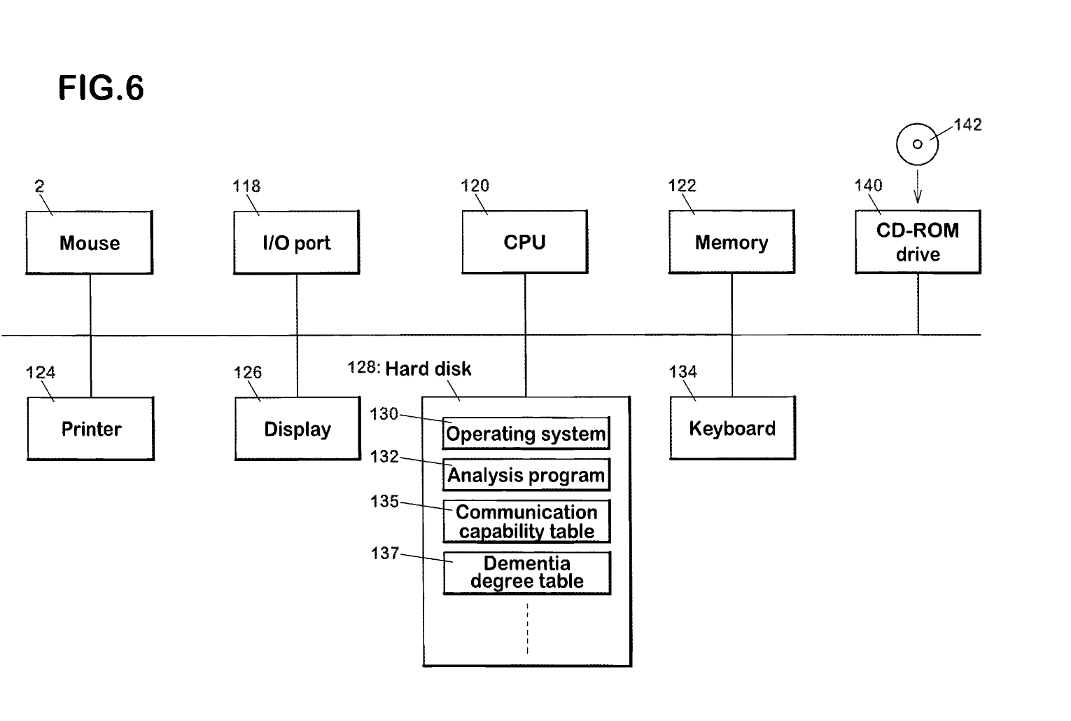

FIG. 6 shows hardware structure realizing the device for judging psychological immunity shown in FIG. 5 using a CPU. Although, in the cases of judging the communication capability and the degree of dementia as the psychological immunity in this embodiment, similar judgment can be performed for the degree of health. The mouse 2 serving as a biological information-measuring instrument has the structure shown in FIGS. 1 through 4.

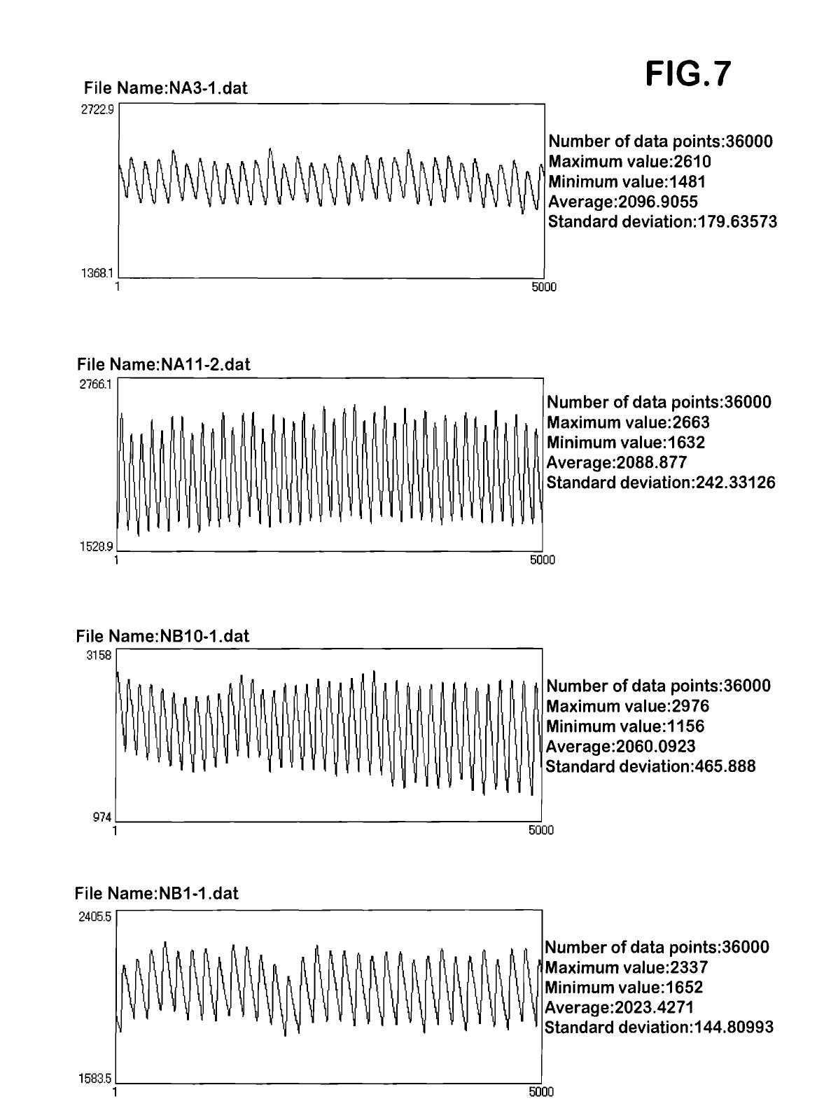

FIG. 7 shows en example of information on blood flow (fingertip pulse waves) output from the mouse 2. Actually, such data is a digital format, but such data is illustrated as waves in the drawings.

A memory 122, a printer 129, a display screen 126, a hard disk 128, a keyboard 134, a CD-ROM drive 140 are connected to a CPU 120 beside the mouse 2. In the hard disk 128, an operating system (WINDOWS (Trademark) of Microsoft and so on) 130, an analysis program 132, a communication capability table 135, a dementia degree table 137 are stored therein. The analysis program 132 collaborates with the operating system and fulfils its function. In addition, the analysis program 132 is a program stored in the CD-ROM 142 and is installed in the hard disk 128 through the CD-ROM drive 140.

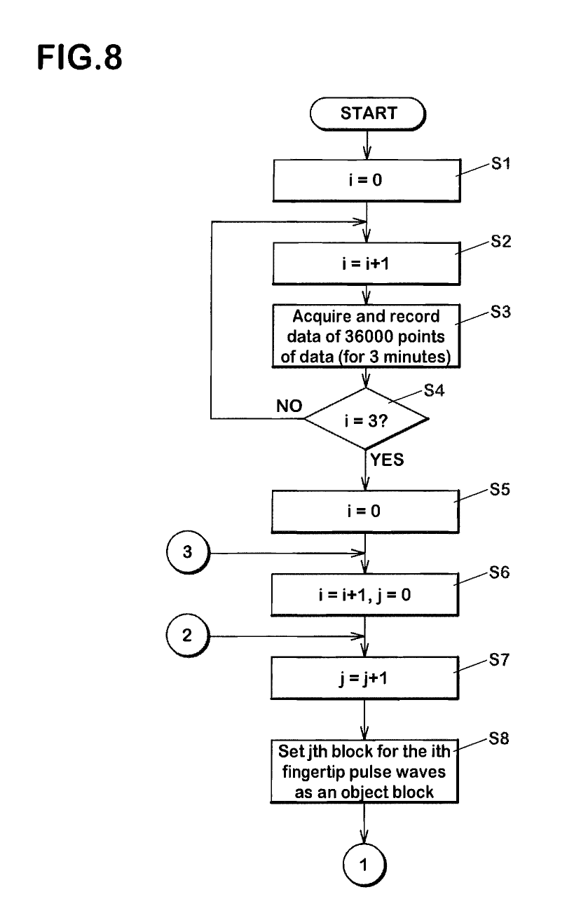

FIG. 8 shows a flowchart of the analysis program 132. The CPU 120 sets i to “0” in step S1. Subsequently, “1” is added to the i and makes i to “1” (step S2). Then the CPU 120 acquires the output from the mouse 2 and records it into the hard disk 128 (step S3). In this embodiment, data for 3 minutes (data of 36000 points) is supposed to be recorded. In other embodiment, data longer or shorter than 3 minutes may be recorded.

Once data of fingertip pulse waves for 3 minutes is recorded, the CPU 120 judges whether i equal 3 (step S4). Here, steps after the step S2 are carried out since i equal 1. In other words, data of fingertip pulse waves for 3 minutes is recorded as i equal 2.

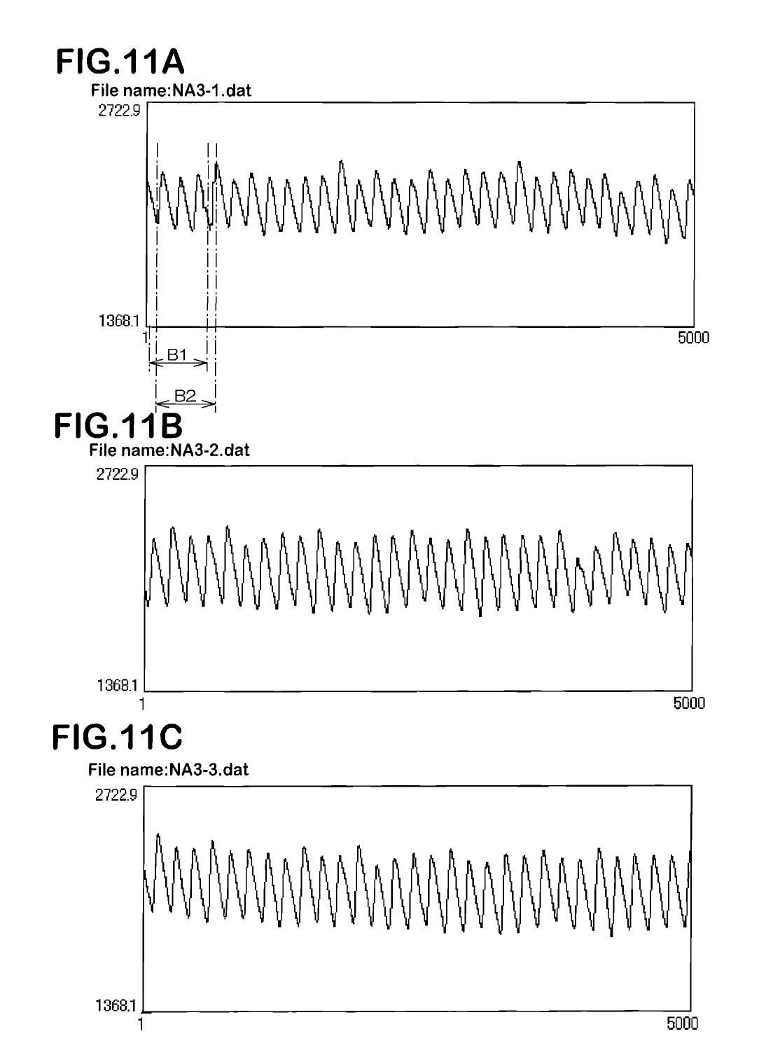

Thus, the CPU 120 records the data of fingertip pulse waves for 3 times into the hard disk 128. FIGS. 11A, 11B and 11C show such recorded data of fingertip pulse waves for 3 times. FIG. 11A shows the first data of fingertip pulse waves, FIG. 11B illustrates the second data of fingertip pulse waves and FIG. 11C shows the third data of fingertip pulse waves.

Once the data for 3 times has been recorded (to be i equal 3), the CPU 120 sets i equal 0 and j equal 0 (step S5). Subsequently, it sets i equal 1 and j equal 1 (steps S6 and S7), and the first block of the first data of fingertip pulse waves is set as an object block (step S8). In this embodiment, the data of 3500 points from the beginning is considered as the first block B1 as shown in FIG. 11A

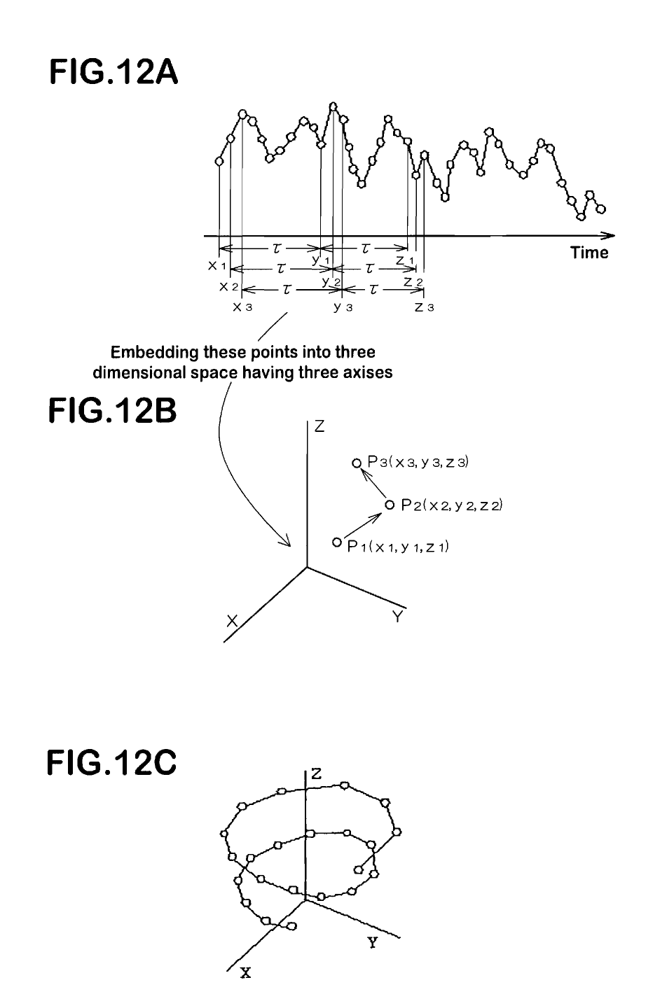

The CPU 120 reconstructs chaos attractors under the condition of setting the dimension for embedding to nth and setting the delay for embedding to τ by Taken's embedding theorem with regard to the fingertip pulse waves of the object block(s) (step S9). FIGS. 12A to 12C show procedure for constructing chaos attractors from fingertip pulse wave data. The fingertip pulse wave data in a chorological format is set to w (t) (FIG. 12A). the CPU 120 generates a vector P (i)=w (i), w (i+τ), w (i+2τ) (see FIG. 12A). It is assumed that such vector is recognized as 3D vector for description. Here, τ means embedding delay.

Sequential plot within a 3D reconstruction space is carried out on the vector P (i) as shown in FIG. 12B. The coordinate axis of this 3D reconstruction space is Xi=w (I), Yi=(i+τ), Zi=(i+2τ). In this way, the attractor shown in FIG. 12C can be obtained.

In this embodiment, the dimension n for embedding is set to 4 and embedding delay τ is defined to 10 points (10 sampling points). Alternatively, the dimension n for embedding and the embedding delay τ may also be other value. The CPU 120 stores the attractor (vector P (i)) thus calculated into the hard disk 128.

Subsequently, the CPU 120 calculates Lyapunov exponent for each dimension of the calculated attractor (step S10). Here, the Lyapunov exponent refers to a criterion for measuring how far two trajectories {xₙ} departing from two adjacent points apart from each other when n becomes with respect to a dynamical system in which xₙ₊₁=f(xₙ). The CPU 120 calculates Lyapunov exponents for each dimension with the following equation.

$$\begin{matrix}λ ( f ) = {lim}_{N -> + ∞} \frac{1}{N} log \frac{d {f}^{N} ( {x}_{0} )}{d {x}_{0}} \\ = {lim}_{N -> ∞} \frac{1}{N} {\sum }_{i - 0}^{N - 1} log \vert {f}^{1} ( {x}_{i} ) \vert\end{matrix} \qquad [ Equation 1 ]$$

The CPU 120 recognizes the greatest one among each of the Lyapunov exponents for 4 dimensions calculated according to the above equation as a representative value and specifies it as the maximum Lyapunov exponent λ(i, j) (step S11). Thus, the maximum Lyapunov exponent λ(1, 1) with respect to data of the first block (J=1) of fingertip pulse wave in the primary measurement (i=1) is obtained. The CPU 120 stores the maximum Lyapunov exponent λ(1,1) into the hard disk 128.

Subsequently, the CPU 120 judges whether the maximum Lyapunov exponent is calculated for all the blocks of the fingertip pulse waves in the first measurement (step S12). If unprocessed block(s) exists, the process returns to step S7 and add “1” to j. Here, j equal 2. Hence, the second block is appointed as the object block (step S8), and the steps subsequent to S9 are repeatedly carried out.

In this embodiment, the second block B2 has the same number of points to that of the first block B1 (3500 sampling points) as shown in FIG. 11A, the former is positioned 200 sampling points away from the latter. The CPU 120 also calculates the maximum Lyapunov exponent λ(1,2) for the second block B2 and stores it into the hard disk 128.

When the maximum Lyapunov exponents for all the blocks in the fingertip pulse waves measured in the first measurement are calculated by repeatedly carrying out the above steps (step S12), it is judged whether i equal 3 (in other words, judgment whether the process for all the measurement for all the blocks of the fingertip pulse waves in the third measurement has been completed) (step S13). Here, since i equal 1, the process returns to step S6 and making i to 2, and the steps subsequent to S7 are repeatedly carried out with respect to the second fingertip pulse waves (FIG. 11B). In this way, the maximum Lyapunov exponents λ(2,1) through λ(2,k) for each block in the fingertip pulse waves measured in the second measurement can be calculated and stored.

Similarly, the CPU 120 proceeds the process from step S13 to step S14 when the maximum Lyapunov exponents λ(3,1) through λ(3,k) for each block in the fingertip pulse waves measured in the third measurement are stored.

In step S14, at first, the maximum Lyapunov exponents λ(1,1), λ(2,1) and λ(3,1) for the first block in the fingertip pulse waves measured in the first to the third measurements are read out from the hard disk 128 and weighted average λ(1) is calculated through offset weighting.

In this embodiment, the weighted λ(1) is calculated as below. At first, the CPU 120 calculates a differential DEF between the maximum value and the minimum value among the maximum Lyapunov exponents λ(1,1), λ(2,1) and λ(3,1) for the first block. In the mean time, an average value M of the maximum Lyapunov exponents λ(1,1), λ(2,1) and λ(3,1) for the first block is calculated. If the differential DEF is less than the average value M, the average value M is used as the weighted average λ(1). On the other hand, if it is not the case, the medium value of the maximum Lyapunov exponents λ(1,1), λ(2,1) and λ(3,1) is used as the weighted average λ(1).

Subsequently, the maximum Lyapunov exponents λ(1,2), λ(2,2) and λ(3,2) for the second block are read out from the hard disk 128, and its weighted λ(2) is calculated. The CPU 120 calculates weighted λ(1) by carrying out these processes repeatedly.

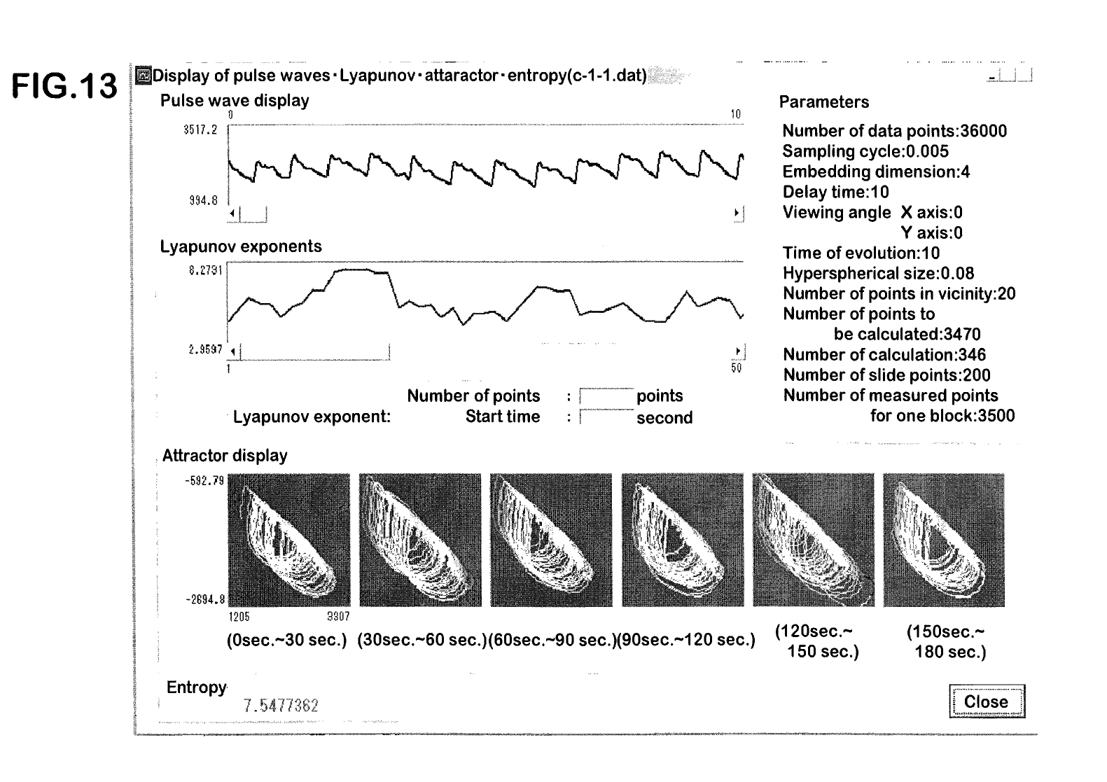

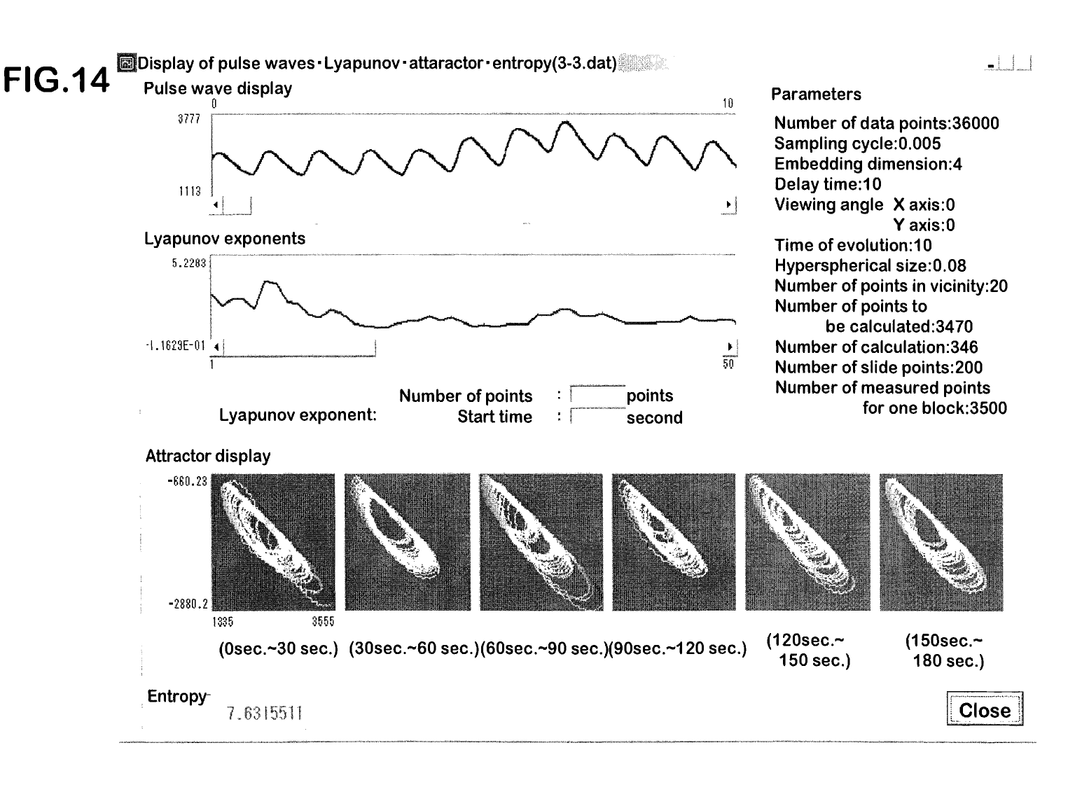

Subsequently, the CPU 120 displays the fingertip pulse waves, the maximum Lyapunov exponents, attractors and so on stored in the hard disk 128 on the display screen 26 (step S15). FIGS. 13 and 14 show display examples thereof. FIG. 13 shows the fingertip pulse waves in the first measurement, the maximum Lyapunov exponents λ(1,1) through λ(k, 1) aligned in chronological order, attractors and so on. In this embodiment, four-dimension attractors are displayed by utilizing length, width, height and colors.

FIG. 14 shows the fingertip pulse waves of the second measurement, the maximum Lyapunov exponents λ(1, 2) through λ(k, 2) aligned in chronological order, attractors and so on. Not shown in figures, the fingertip pulse waves of the third measurement, the maximum Lyapunov exponents λ(1, 3) through λ(k, 3), attractors and so on are displayed thereon.

Next, the CPU 120 calculates standard deviation of Weighted λ(1) through Weighted λ(k) of Lyapunov exponents (step S16). Further, the CPU 120 determines the degree of communication capability and that of dementia in accordance with the calculated standard deviation with reference to a communication capability table 135, and a dementia degree table 137 (step S17).

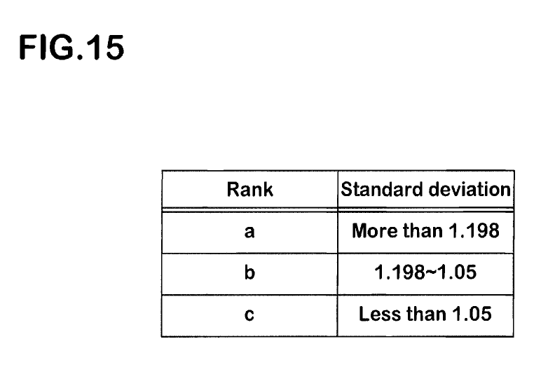

FIG. 15 shows an example of the communication capability table 35. The ranks thereof show the degree of communication capability such as rank a represents “having perfect communication ability”, rank b shows “having a certain level of communication capability” and rank c represents “having very poor communication capability”. The ranks a, b and c are respectively determined such that when the standard deviation exceeds 1.198, it is considered as rank a, the standard deviation is in a range between 1.198 to 1.05, it is considered as rank b and the standard deviation is lower than 1.05, it is considered as rank c.

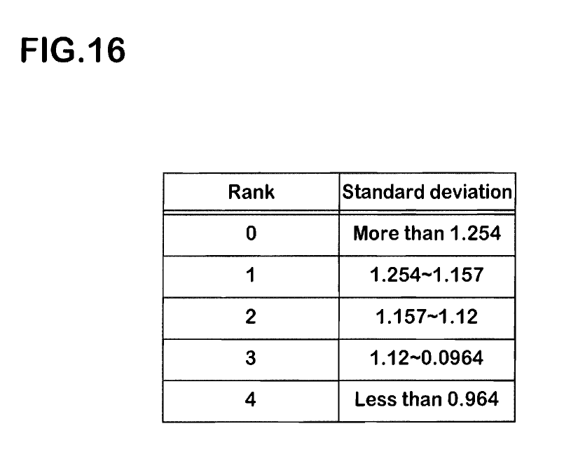

FIG. 16 shows an example of the dementia degree table 37. The ranks show the degrees of dementia. In the table, the larger the value, the worth the degree of dementia. Ranks 0, 1, 2, 3 and 4 respectively correspond to “no dementia”, “slight”, “moderate”, “heavy” and “profound level”. The ranks 0, 1, 2, 3, and 4 are respectively determined such that when the standard deviation exceeds 1.254, it is considered as rank 0, the standard deviation is in a range between 1.254 to 1.157, it is considered as rank 1, the standard deviation is in a range between 1.12 to 0.964, it is considered as rank 3 and the standard deviation is less than 0.964, it is considered as rank 4.

The CPU 120 displays the result of determination on the display screen 126 (step S18). In this way, communication capability and the degree of dementia can be determined quickly and objectively.

The above communication capability table 135 and the dementia table 137 are obtained in accordance with the fact that a relationship between communication capability/the degree of dementia and standard deviations of the weighted average λ of Lyapunov exponents is found through the experiment(s) and the research(es) conducted by the inventor.

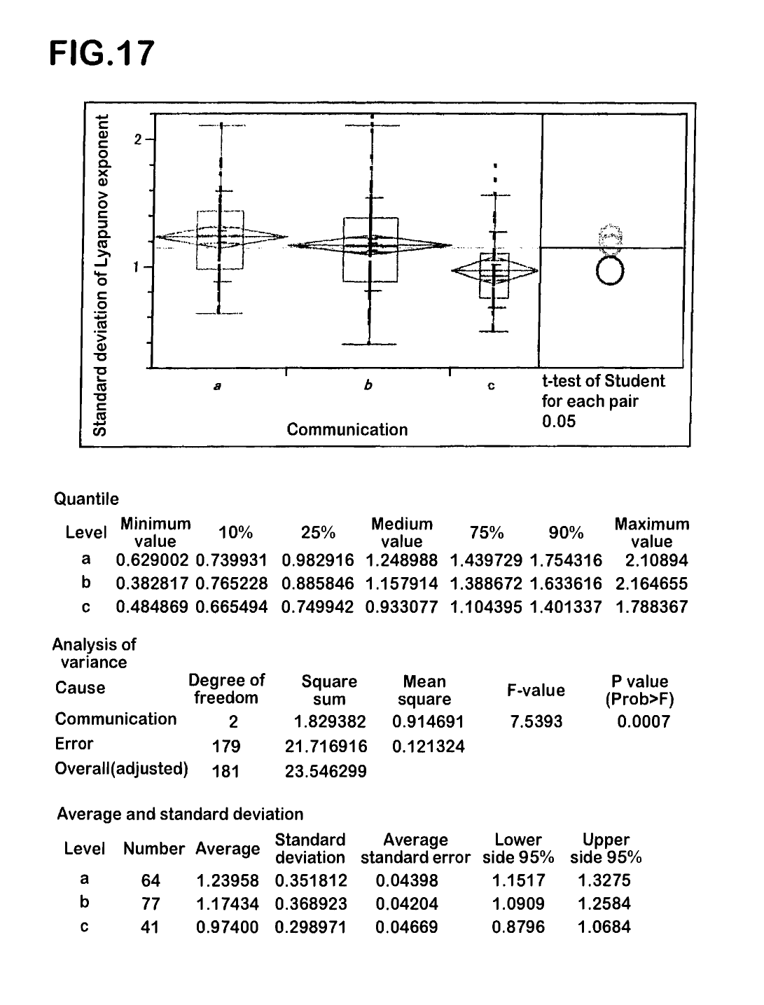

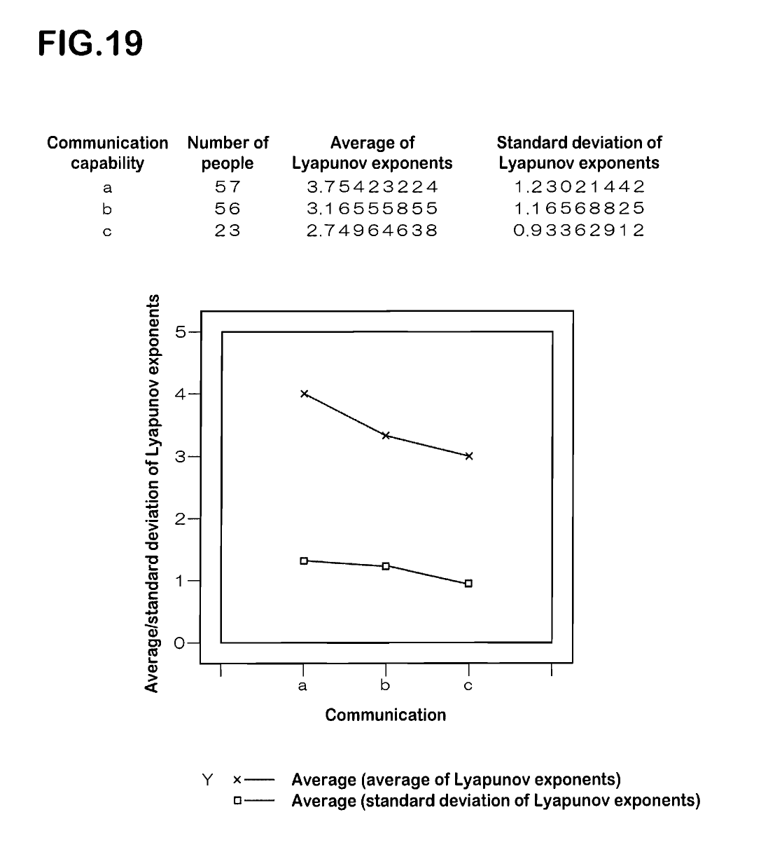

FIGS. 17 and 19 show result of the research on communication capability and standard deviation thereof conducted by the inventor. From the result of experiment/research, it is understood that communication capability can be determined in accordance with standard deviations of the weighted average λ of Lyapunov exponents.

In the communication capability table 135, the medium value of the average of standard deviations of people belong to the rank a obtained from the experiment/research and the average of standard deviations of people belong to the rank b is defined as a first value (1.198 in FIG. 15), the medium value of the average of standard deviations of people belong to the rank b and the average of standard deviations of people belong to the rank c is defined as a second value (1.05 in FIG. 15), and it is defined as the rank a when the value of the standard deviations is larger than the first value, it is defined as the rank b when the value of the standard deviations is in a range between the first value and the second value, and it is defined as the rank c when the value of the standard deviations is less than the second value. In this embodiment, the first value/second value are used for the middle value, but a value(s) other than the middle value may also be adopted.

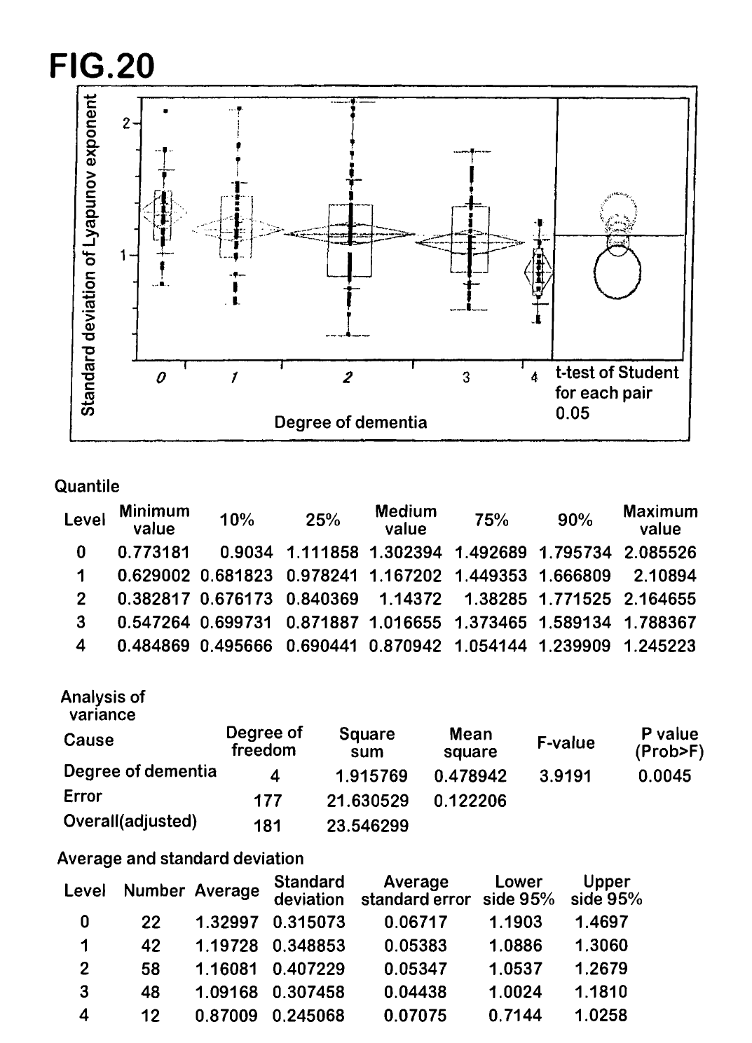

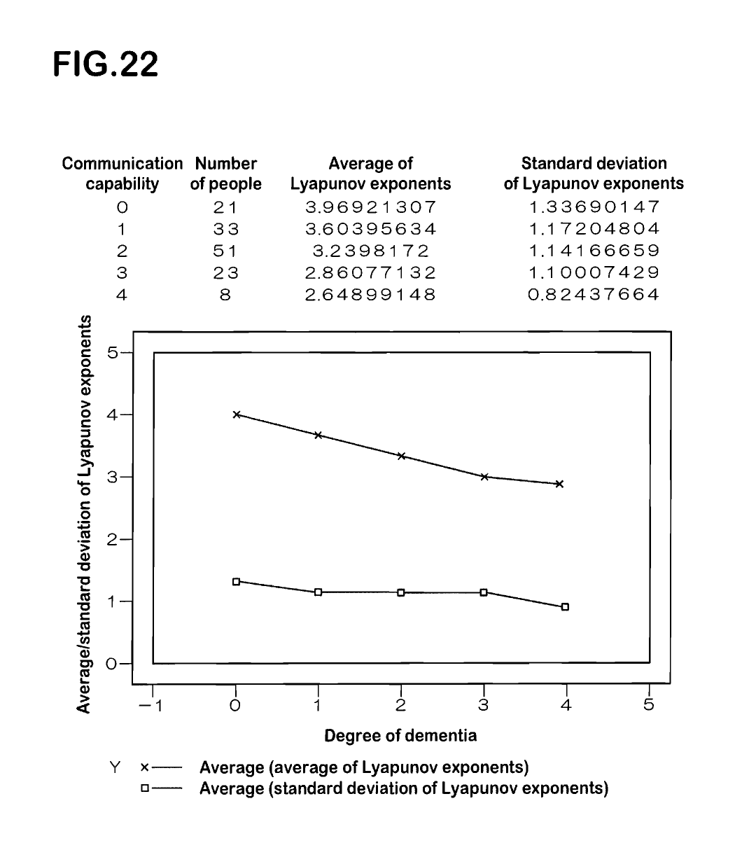

FIGS. 20 and 22 show result of the research on dementia conducted by the inventor and standard deviation thereof. From the result of experiment/research, it is understood that the degree of dementia can be determined in accordance with standard deviations of the weighted average λ of Lyapunov exponents.

In the dementia degree table 137 of FIG. 16, the medium value of the average of standard deviations of people belong to the rank 0 obtained from the experiment/research and the average of standard deviations of people belong to the rank 1 is defined as a first value (1.254 in FIG. 16), the medium value of the average of standard deviations of people belong to the rank 1 and the average of standard deviations of people belong to the rank 2 is defined as a second value (1.157 in FIG. 16), and values up to a fourth value are calculated utilizing similar method to the above. It is defined as the rank 0 when the value of the standard deviations is larger than the first value, it is defined as the rank 1 in when the value of the standard deviations is in a range between the first value and the second value, and it is defined as the rank 2 when the value of the standard deviations is in a range between the second value and the third value, it is defined as the rank 3 when the value of the standard deviations is in a range between the third value and the fourth value and it is defined as the rank 4 when the value of the standard deviations is less than the fourth value. In this embodiment, the first value/second value are used for the middle value, a value(s) other than the middle value may also be adopted.

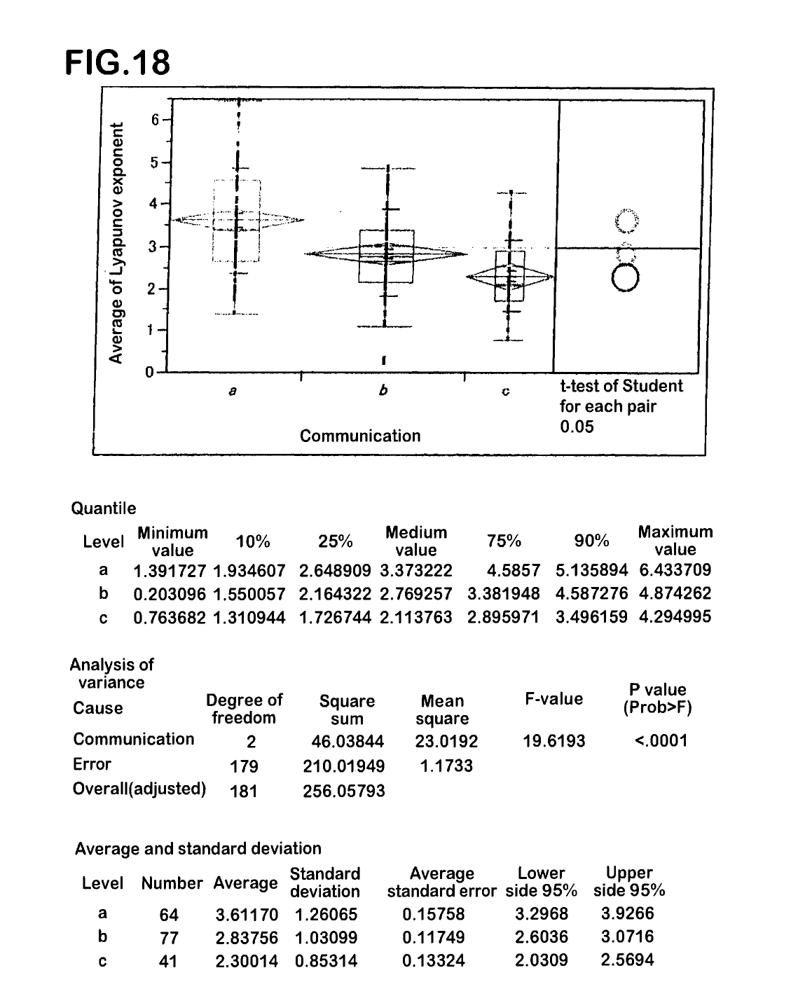

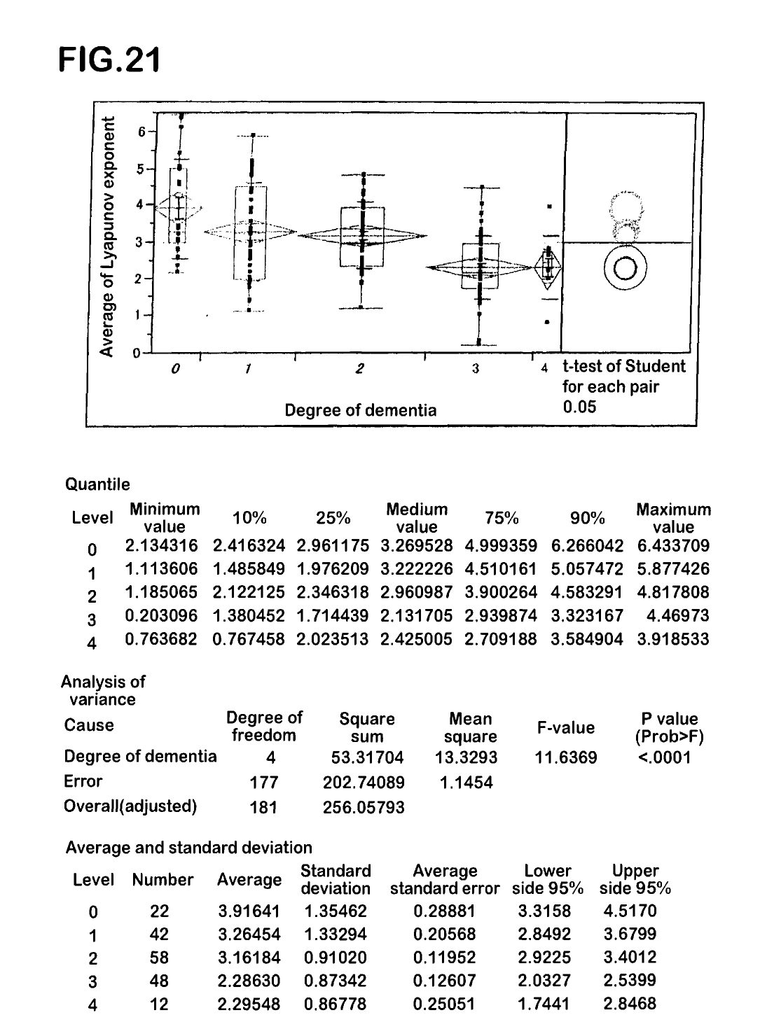

In the below description, communication capability and the degree of dementia are determined using standard deviations of the weighted λ of Lyapunov exponents. According to the experiment/research conducted by the inventor, however, a relationship between the average value of standard deviations of the weighted λ of Lyapunov exponents and the degree of dementia is found as shown in FIGS. 18 and 19. Similarly, a relationship is found between the average value of standard deviations of the weighted λ of Lyapunov exponents and the degree of dementia as shown in FIGS. 21 and 22. In this way, communication capability and the degree of dementia can be determined in accordance with the average value of standard deviations of the weighted λ of Lyapunov exponents as a result of generating standard deviations the similar to the above.

According to an experiment(s) conducted by the inventor, it is also found that the object person has been in a highly stressful state when standard deviations (fluctuations) have been low for long time even if the average value of Lyapunov exponents is high. Under the circumstances, the degree of psychological immunity can be determined by the CPU 120 in accordance with both the average value of Lyapunov exponents and standard deviations (fluctuations).

In the above-described embodiment, communication capability and the degree of dementia are determined in accordance with standard deviation and the average value of standard deviations and output these, but, standard deviations and the average value of standard deviations may be output instead. Communication capability and the degree of dementia may also be determined by the operator according to a diagram of an attractor(s) to be output.

In the above-described embodiments, the result of determination is output through the display thereof on the display screen, alternative output may be a print output by a printer and the like. Possibly, the result of determination may also output on a data storage medium as data.

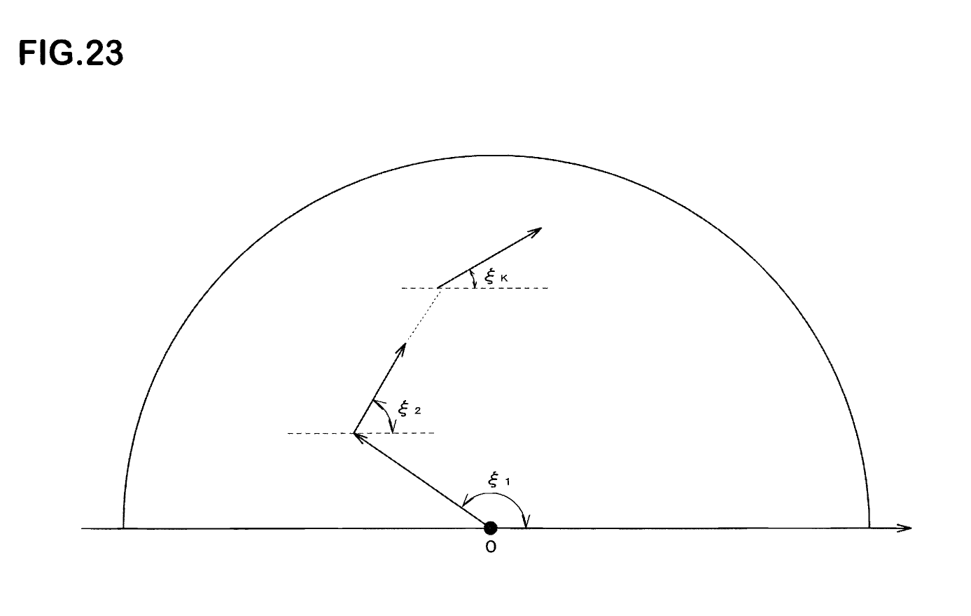

Alternatively, a total of k vector trajectories may be output as a constellation graph by converting the value of weighted λ(1) through weighted λ(k) of Lyapunov exponents. The CPU 120 calculates angles ξ1 through ξk corresponding to the values of weighted λ(1) through weighted λ(k) of Lyapunov exponents. In this embodiment, the angle is made greater in proportion to weighted λ become larger. Subsequently, the CPU 120 draws a vector, the origin thereof is 0 and with an angle of ξ1 corresponding to the value of weighted λ(1) as shown in FIG. 23. Another vector, the origin thereof is the forefront of the former drawn vector and with an angle of ξ2 corresponding to the value of weighted λ(2), is drawn. Vectors are drawn until the angle of ξk corresponding to the value of weighted λ(k) is satisfied by repeating the similar process. The length of each vector made to the same regardless of the value of weighted λ.

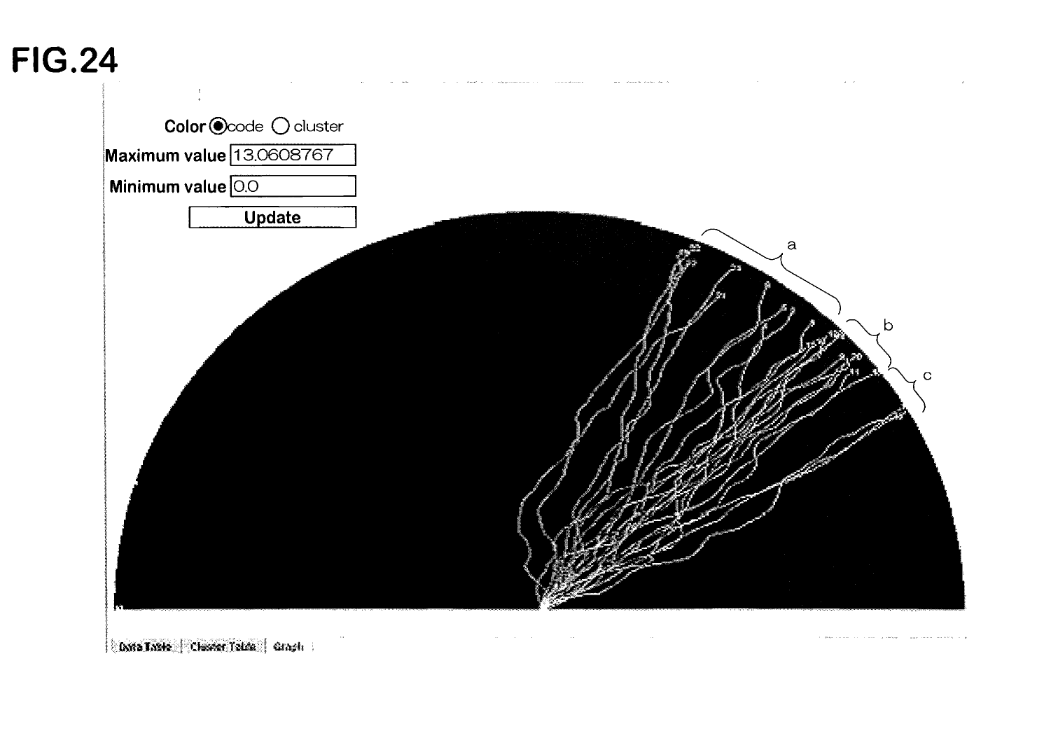

FIG. 24 shows a constellation graph thus drawn. The trajectories with symbol a in the figure represent people belong to rank a for communication capability, the trajectories with symbol bin the figure represent people belong to rank b for communication capability and the trajectories with symbol c in the figure represent people belong to rank c for communication capability, so that these trajectories can clearly be distinguished one another. Thus, the operator can easily determine their communication capability by looking at the constellation graph as a result of previously setting the rank of communication capability depending upon regions to which the trajectory(ies) to reach thereto.

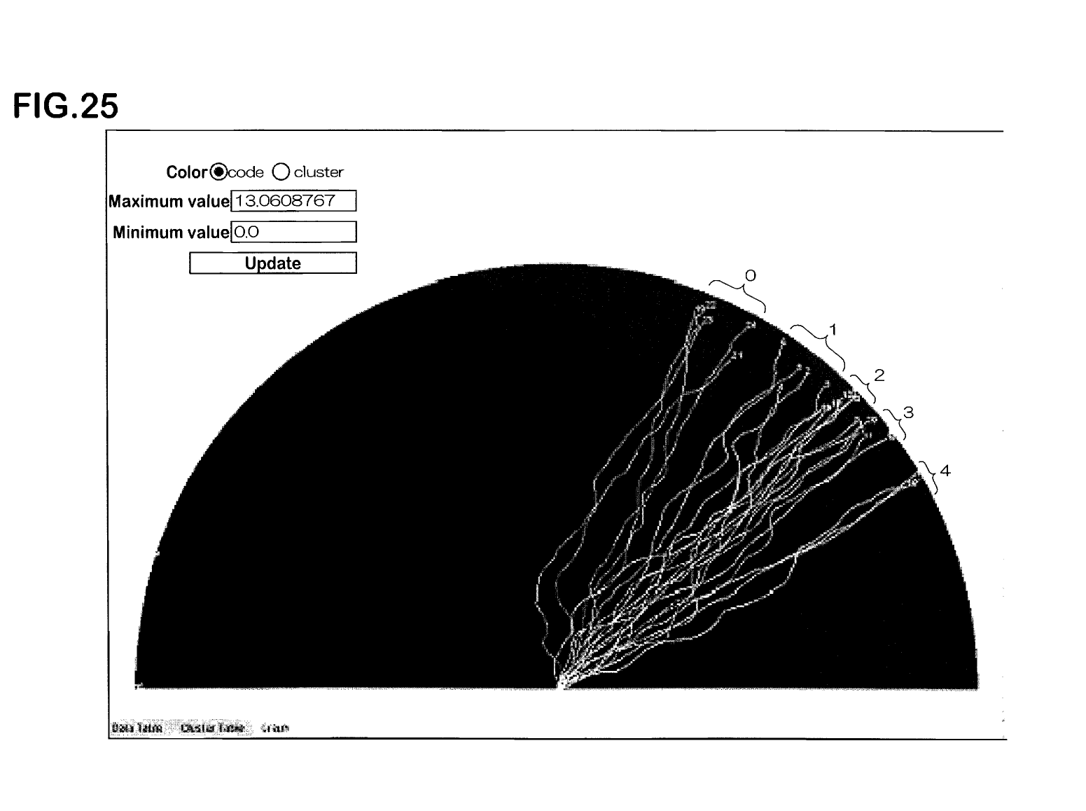

FIG. 25 shows a relationship to the degree of dementia with respect to the same constellation graph. Similar to communication capability, the degree of dementia can also be clearly distinguished thereamong. Thus, the operator can easily determine the degree of dementia by looking at the constellation graph as a result of previously setting the rank of the dementia degree depending upon regions to which the trajectories to reach thereto. With the use of a constellation graph in such a way, both the average value of Lyapunov exponents and fluctuations (corresponding to standard deviation) can be displayed simultaneously.

In the above-described embodiments, a correspondence relationship between the values of weighted λ and angles are previously fixed, and the angle of each vector is determined according to the correspondence relationship. However, in the case of comparing multiple people to be object, angles of the vectors can be determined based on ratios between the weighted λ having the maximum vales and the weighted λ having the minimum values by respectively setting the one having the maximum values among weighted λ(1) through (k) of each object person as 180 degree and the one having the minimum vales thereamong as 0 degree. In other words, the angle of each vector may be determined by the following equation.

ξij=180*(λij−λmin)/(λmax−λmin)

wherein, i is the number of blocks such as 1 though k, j shows the number of people to be object person such as 1 through m (when the number of object person is m). λij shows the weighted λ of the block i of the object person j. λ max indicates the maximum value among all the blocks of all the people to be object and λ min shows the minimum value among all the blocks of all the people to be object.

In the case of comparing multiple people, regions of a constellation graph can be used effectively by determining the above-described way.

Blood flow of fingertip is measured as biological information in the above-described embodiments. Alternatively, blood flow may be measure from other part(s) such as earlobe and so on. As for biological information, not only blood flow rate such as fingertip pulse waves, but also electrocardiographic waveforms, breathing quantity and so on may also be used. In addition, information such as vibrations from the body measured by a piezoelectric sensor(s) and the like may also be used.

In the above-described embodiments, the maximum Lyapunov exponent in each dimension is defined as the representative Lyapunov exponent. However, a Lyapunov exponent in any one of dimensions may also be the representative Lyapunov exponent. Further, the average value of Lyapunov exponent in each dimension may also be defined as the representative Lyapunov exponent.

Lyapunov exponents are calculated in accordance with the four-dimension attractors in the above-described embodiment. Lyapunov exponents may be calculated in accordance with less, equal to three-dimension attractors, greater, or equal to five-dimension attractors.

In the above-described embodiments, standard deviation(s) and/or average value(s) are used as the characteristic value(s), other values such as the maximum value(s), the minimum value (s) may also be used therefor.

The measurement of fingertip pulse waves conducted for three times in the above-described embodiments, such measurements may be conducted for just once. In that case, it is not necessary to calculate the weighted λ, but the maximum Lyapunov exponent can be used as it is. Further, fingertip pulse waves may be measured for less, equal to two times, or greater or equal to four times.

In the above-described embodiments, weighted λ with offset weighting is used, other average value such as simple average may be used.

The device is realized with one computer in this embodiment, this device may be realized with a plural number of computers such as a computer for acquiring and storing biological information, another computer for carrying out processing for judgment. In this case, data exchange among the computers is carried out not only through on-line communications such as the Internet, LAN and so on, but it can also be performed through recording medium.

The first embodiment and its alteration can also be applied to the second embodiment that will be described below.

### 2. Another Embodiment to be the Background

### The Second Embodiment

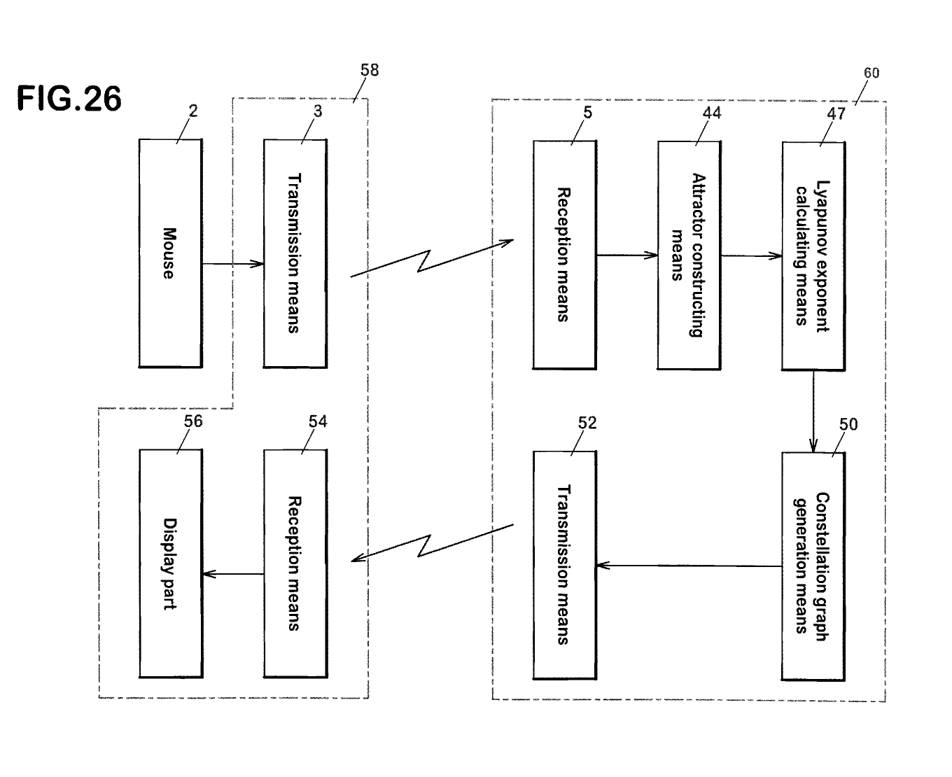

FIG. 26 shows a block diagram of a system for judging psychological immunity degree according to an embodiment that becomes another background of this invention. In this example, the system comprising a mouse 2, a computer 58, a server device capable of communicating with the computer 58. The biological information measured by the mouse 2 is transmitted to the server device 60 by transmission means 3 of the computer 58.

Reception means 5 of the server device 60 receives the biological information from the computer 58. Attractors 44 are constructed in chronological order according to the biological information. Lyapunov exponent calculation means 47 calculates Lyapunov exponents in chronological order in accordance with the attractors. Constellation graph generation means 50 generates a constellation graph through conversion of the chronological Lyapunov exponents into angles. Transmission means 52 transmits data of the generated constellation graph to the computer 58.

Reception means 54 of the computer 58 receives data of the constellation graph. Display part 56 displays the constellation graph in accordance with the data of the generated constellation graph thus received.

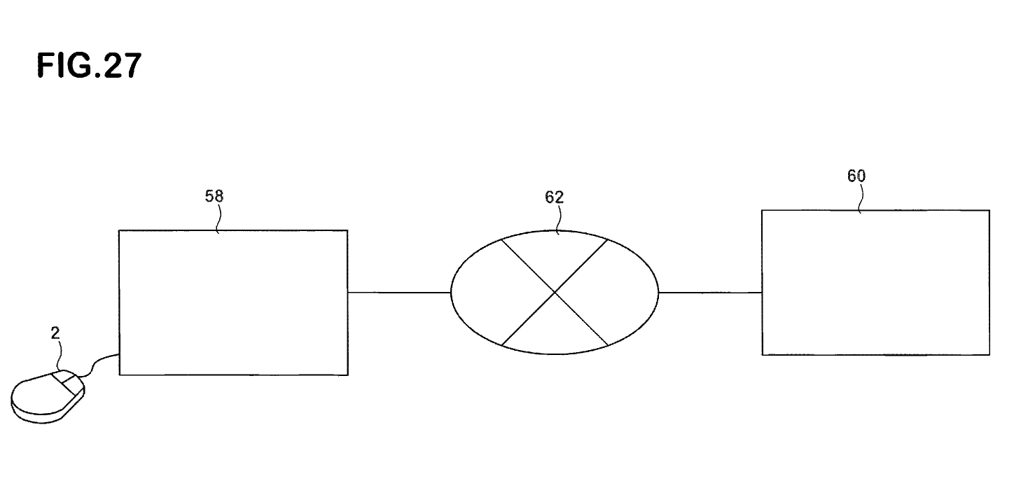

FIG. 27 shows a schematic construction of this system. In this system the mouse 2 is used similar to the system shown in FIG. 5. The computer 58 and the server device 60 are capable of communicating each other via the Internet 62.

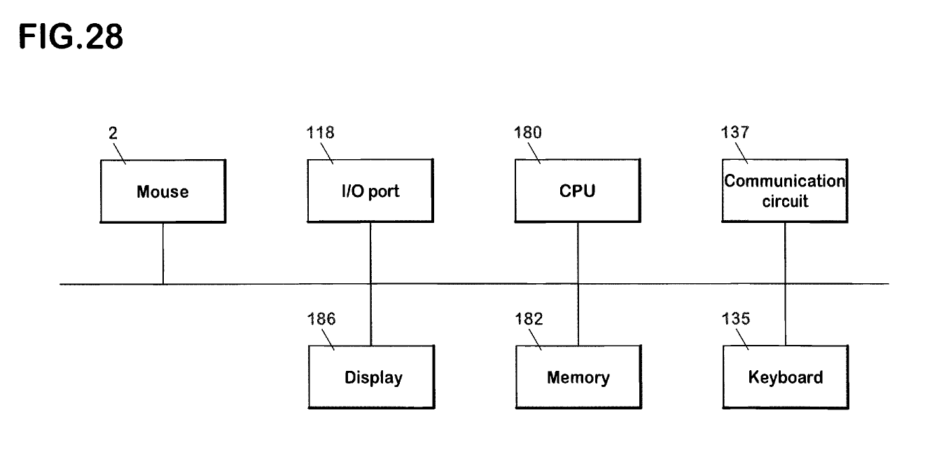

FIG. 28 is a hardware structure of the computer 58. A mouse 2, a display screen 186, a memory 182, a keyboard 135 and a communication circuit 137 are connected to a CPU 180 via an I/O port 118. The communication circuit 137 is a circuit for connecting to the Internet 62. The keyboard 135 is used for data entry by a user. A browsing program(s) and/or a processing program(s) for connecting to the server device 60, for displaying information from the server 60 are stored in the memory 182. The display screen 186 is used for carrying out display thereon.

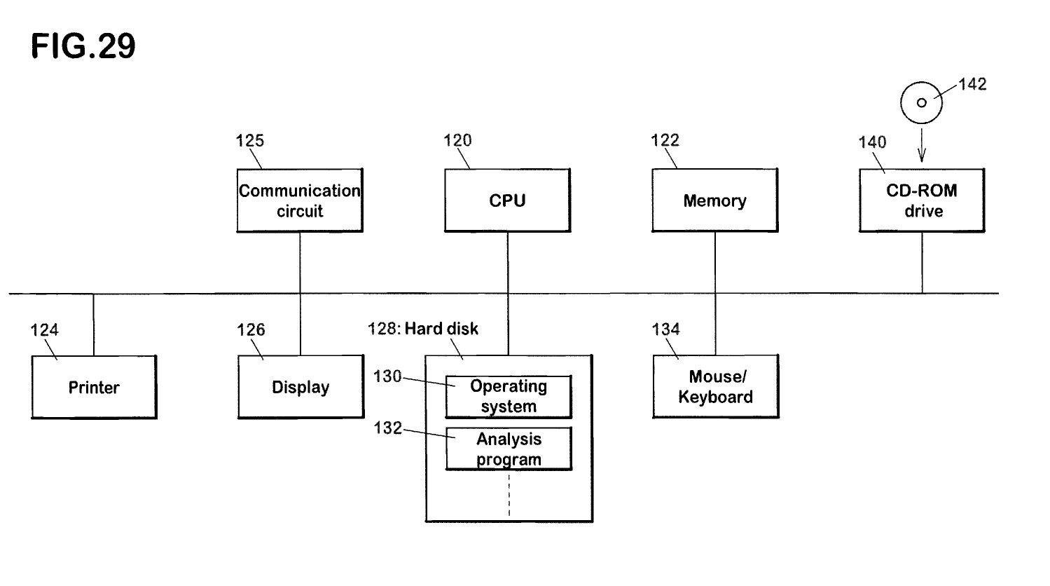

FIG. 29 shows a hardware structure the server device 60.

The memory 122, the communication circuit 125, the display screen 126, the hard disk 128, the keyboard/mouse 134 and the CD-ROM drive 140 are connected to the CPU 120. In the hard disk 128, an operating system (WINDOWS (Trademark) of Microsoft and so on) 130 and an analysis program 132 are stored therein. The analysis program 132 collaborates with the operating system and fulfils its function. In addition, the analysis program 132 is the program stored in the CD-ROM 142 and is installed in the hard disk 128 through the CD-ROM drive 140. The communication circuit 125 is a circuit for connecting to the Internet.

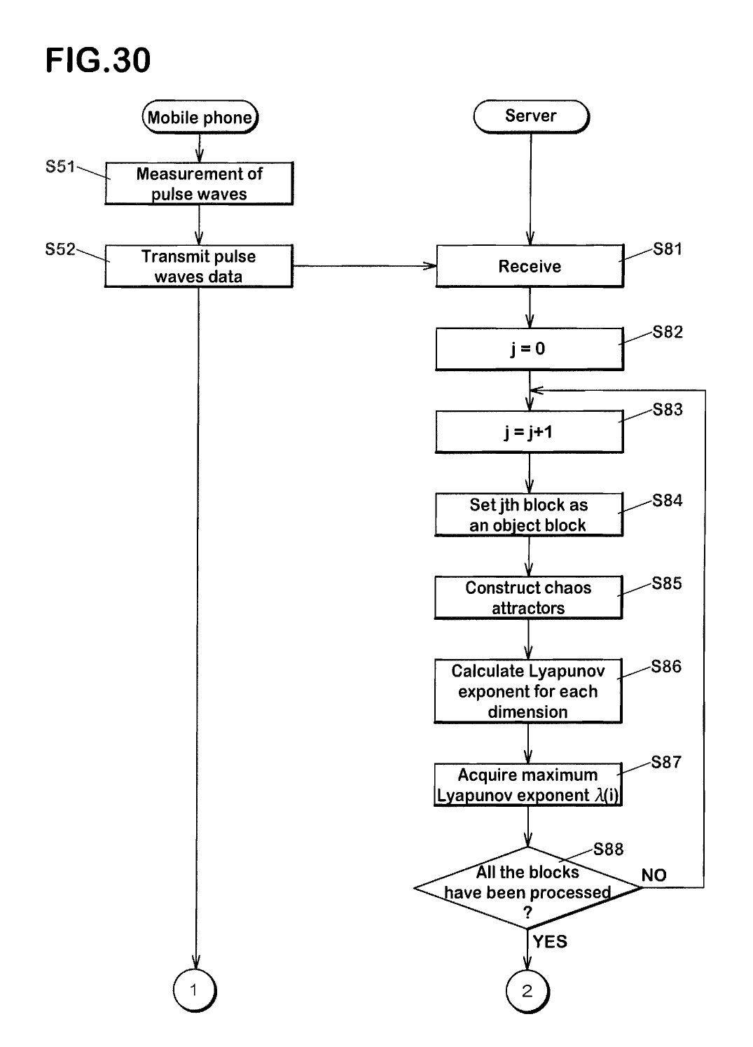

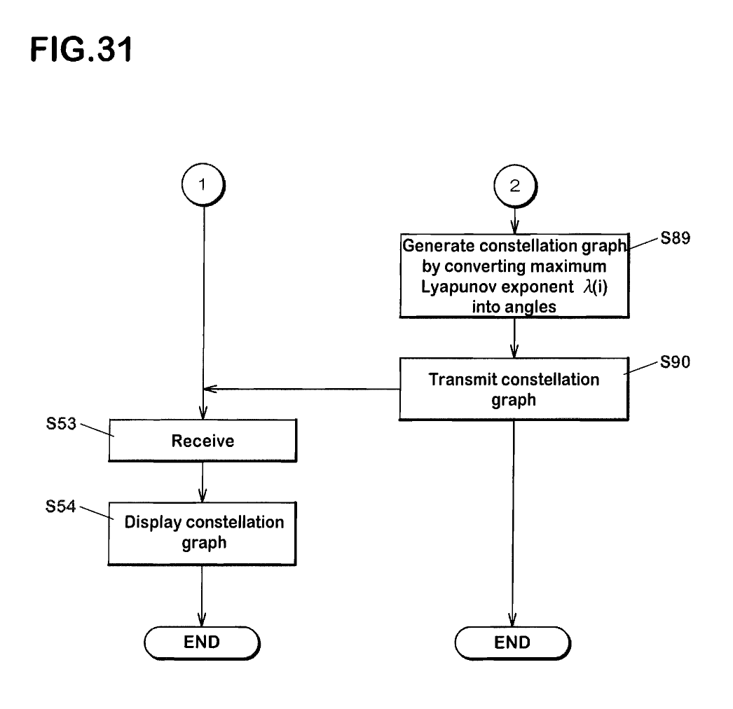

FIGS. 30 and 31 show flowcharts of the browsing program(s) and/or the processing program(s) of the server device 60. Once the user measures fingertip pulse waves using the mouse 2, the CPU 180 acquires data on the fingertip pulse waves and stored it into the memory 182 (step S51). Subsequently, the CPU 180 transmits the fingertip pulse waves data to the server device 60 via the communication circuit 137 (step S52).

The CPU 120 of the server device 60 stores the fingertip pulse wave data thus received into the hard disk 128 via the communication circuit 125 (step S81). The CPU 120 calculates the maximum Lyapunov exponents in chronological order by carrying out steps S82 through S88 with respect to the stored fingertip pulse wave data. Processes performed in steps S82 through S88 are similar to that performed in steps S6 through S12 in the embodiment shown in FIG. 5. The embodiment shown in FIG. 30, however, is differ from the above embodiments in that the maximum Lyapunov exponents are calculated only on the fingertip pulse waves for one cycle. Thus, further processing will be carried out without calculating the weighted λ with offset weighting as in the first embodiment.

In step S89, the CPU 120 generates a constellation graph in accordance with the maximum Lyapunov exponents λ(j) in chronological order thus calculated.

The CPU 120 calculates angles ξ1 through corresponding to the values of the maximum Lyapunov exponents λ(1) through λ(k). In this embodiment, the angle ξ is made greater in proportion to weighted λ become larger. Subsequently, the CPU 120 draws a vector, the origin thereof is 0 and with an angle of ξ1 corresponding to the value of weighted λ(1) as shown in FIG. 23. Another vector, the origin thereof is the forefront the former drawn vector and utilizing an angle of ξ2 corresponding to the value of weighted λ(2), is drawn. Vectors are drawn until the angle of ξk corresponding to the value of weighted λ(k) is satisfied by repeating the similar process. The length of each vector made the same regardless of the value of weighted λ.

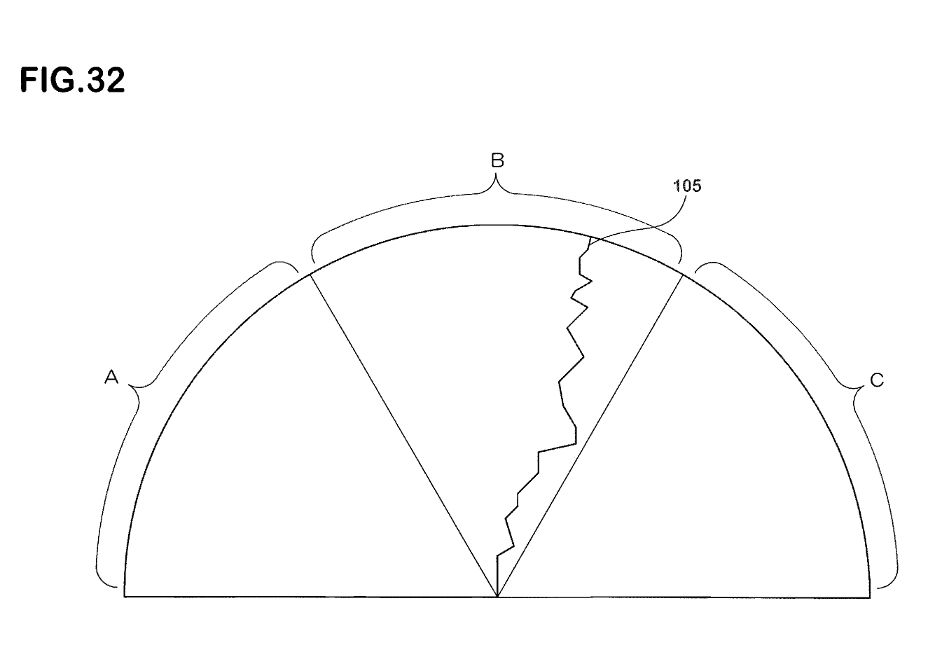

FIG. 32 shows a constellation graph chart thus generated. The drawable regions of the graph are indicated by three regions A, B and C with different colors, and a constellation graph 105 is displayed thereon. The degree of psychological immunity is higher in the order of regions A, B, C. The CPU 120 transmits to the computer 58 via the communication circuit 125 data of this constellation graph chart.

The CPU 180 of the computer 58 receives the data via the communication circuit 137 (step S53) and displays it on the display screen 186. In this way, the user can see the constellation chart shown in FIG. 32. It is possible to judge the degree of psychological immunity on which region the constellation chart 105 being located. The amplitude of fluctuation (s) can be recognized depending on the degree of fluctuation (s) of the constellation graph 105. Lower amplitude of the fluctuation (s) makes the constellation graph in linear shape, so that the graph unexpectedly reaches to the arc 300. Higher amplitude of the fluctuation (s) makes the constellation graph in more zigzag shape, so that the graph does not reach to the arc 300. Under the circumstances, how close the graph to the arc 300 can be one of the criteria.

Although, the computer 28 is used as a terminal device, other instrument(s) capable of being connected to the Internet such as PDA and/or mobile phone may also be used as the terminal device.

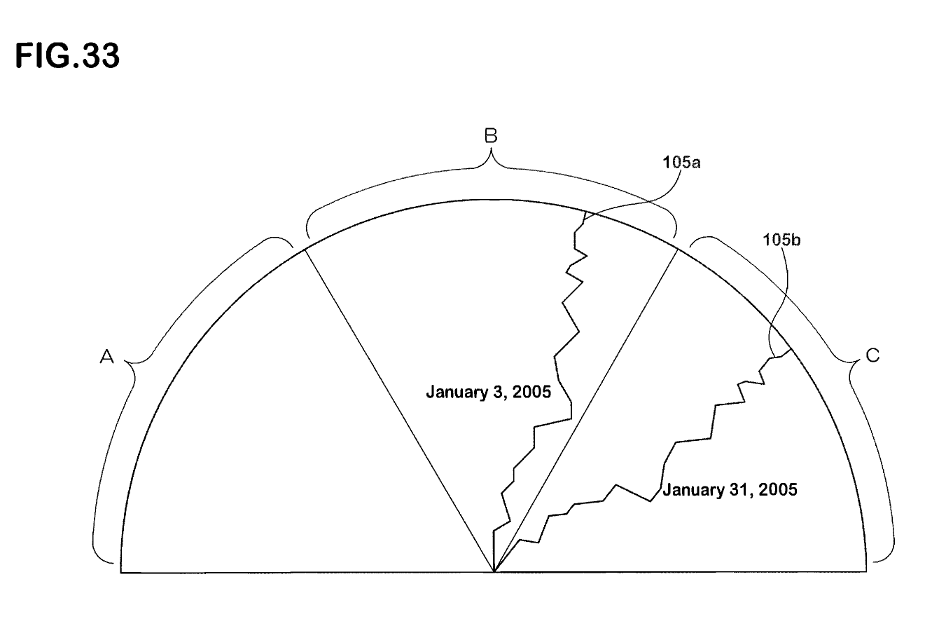

Not only the current constellation graph 105a, but also the past constellation graph 105b may be indicated as history thereof as shown in FIG. 33 by storing on the server side the constellation graph so as to correspond to the date of acquisition of biological information for each user. At that time, the date of measurement is preferably displayed at a position vicinity of each constellation graph as shown in the figure. By indicating its history, the user can recognize variation(s) of psychological immunity.

Measurement is carried out for just once in this embodiment, processing may be performed through calculation of weightened λ by carrying out a plural number of measurements as the embodiment shown in FIG. 5.

Although, a constellation graph is transmitted to the computer 28 and displayed thereon in this embodiment, the degree of psychological immunity calculated in the first embodiment and the like may be transmitted and displayed alternative (or additional) to the constellation graph.

In each of the above-described embodiments, judgment on communication capability and/or the degree of dementia is carried out, similar judgment may also be carried out on psychological data related to other psychological immunity such as traveling, dining, bathing, changing clothes, relaxing.

### 3. Another Embodiment of the Present Invention

### The Third Embodiment

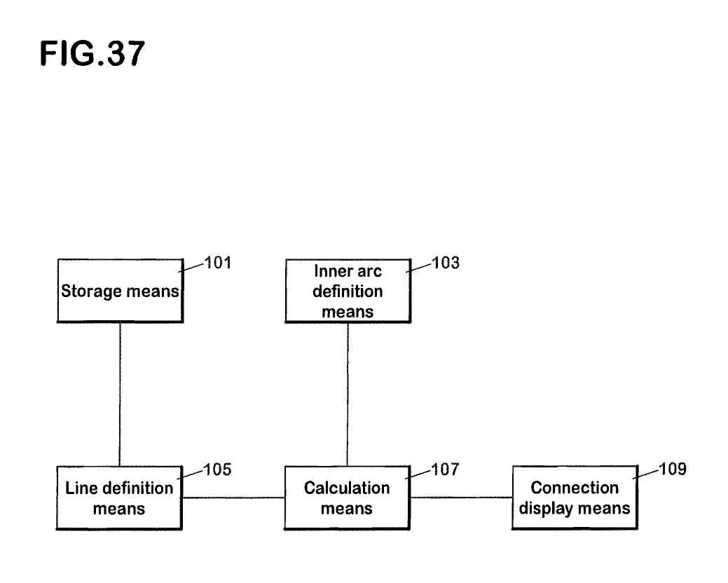

FIG. 37 shows a functional block diagram of a history display system 100 for data to be displayed according to the present invention.

The history display system 100 for data to be displayed is a system for displaying history of data to be displayed in a constellation graph by displaying a line segment from the center of the arc to a specific position on the arc with an angle corresponding to the value of the data to be displayed. The system 100 comprises storage means 101, arc definition means 103, straight line definition means 105, intersection calculation means 107 and connection display means 109.

The storage mean 101 stores plural number of data to be displayed in chronological order. The arc definition means 103 defines predetermined numbers of concentric arcs that enlarge in predetermined interval from a reference arc. The straight line definition means 105 reads out plural number of data to be displayed from the storage mean 101 in sequential ascending order and defines plural straight lines passing through the center of the reference arc and defining with angles corresponding to the data to be displayed in ascending order. The intersection calculation means 107 calculates plural number of intersections for a straight line of the pth order out of the defined ascending straight lines and a concentric arc of the pth order from the reference arc while varying the number representing the order of p. The connection display means 109 connects the plural intersections calculated by the intersection calculation means 107 with line segments in chronological order and displays them.

In this embodiment, the history display system 100 for data to be displayed is constructed by a mobile phone 58 forming a terminal computer and the server device 60 as shown in FIG. 27. The hardware structures of the mobile phone 58 and that of the server device 60 do not described herein, because the structure thereof is similar to FIGS. 28 and 29.

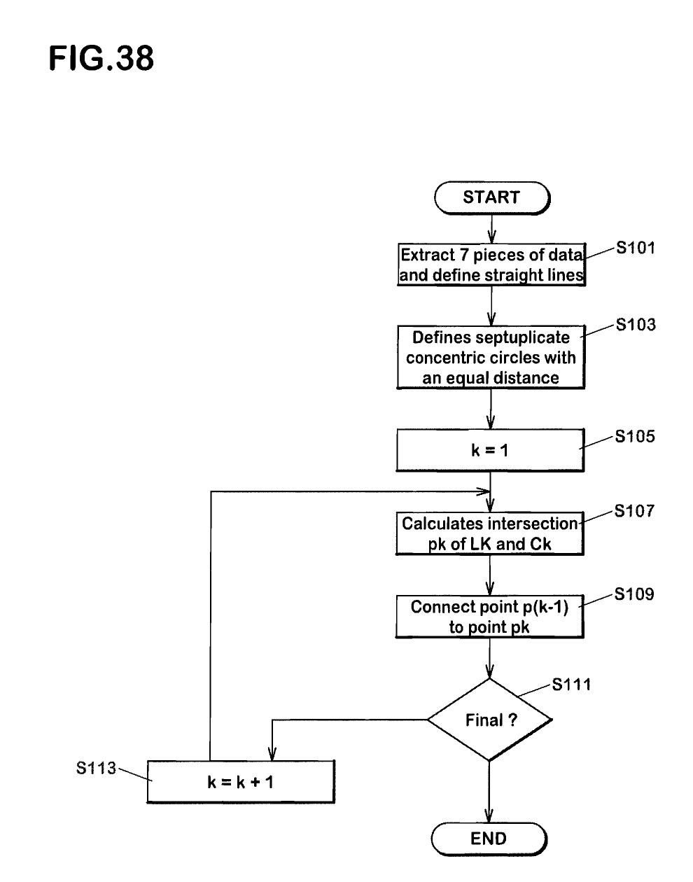

Subsequently, display processing in this system will be described with reference to FIG. 38. Here, it is assumed that the result of measurement has already been transmitted from the mobile phone 58, and measurement result for a total of 7 days once a day is stored in chronological order in the hard disk 28 and the operator of the mobile phone 58 requests for the display of history data by accessing to a predetermined URL of the server device 60 using a browsing program(s) installed in the memory 182.

A calculation method of Lyapunov exponent according to the one-time measurement result will be described. In this embodiment, the duration of measurement is set to as one minute similar to the second embodiment. Pulse wave data of 12000 points is obtained for one-time measurement because the pulse wave data is detected 200 times per second. Similar calculation processing to that of the second embodiment is carried out on the obtained data in order to obtain 43 of Lyapunov exponents and the average value m thereof is set as measured value.

Specifically, a Lyapunov exponent from the beginning to the 3500 points is calculated. Subsequently, another Lyapunov exponent at the 3500 points from the 200 points to the 3700 points is calculated by shifting the beginning for 200 points. A total of 43 Lyapunov exponents can be obtained because an equation of (12000−3500)/200=42.5 is satisfied by repeating the above for a period capable of performing calculation using the calculation at 3500 points. The 3500 points and/or the amount of shifting are not an absolute value(s), it may vary depending upon the characteristic of the object to be measured.

The CPU 120 extracts 7 pieces of chronological order data for the data thus measured, and calculates angles ξ from each values and defines 7 straight lines L1 through L7 (steps S101 of FIG. 38). For example, the straight line L1 is defined using the origin 0 as the basing point with an angle ξ1 corresponding to the value of λ(1). Similar definition is carried out for the straight lines L2 through L7. In this way, seven of straight lines are defined in chronological order. It is similar to the second embodiment for the method of calculating angles ξ from each value, such method will be briefly described hereunder.

Experimental rule shows that pulse wave data is categorized in a range of 0 to 10. In constellation graphs, the display may be of M=0 and M=10 when 0 degree and 10 degrees respectively during the range of Lyapunov exponents is in 0 through 10 in order to show the distribution. Under the circumstances, when an average value M of 43 Lyapunov exponents is “5”, an equation ξ1=(180XM)/10=90 degrees is satisfied.

Although, angles of the straight lines in this embodiment are defined in the opposite direction to that defined in FIG. 23, they may set to the same direction.

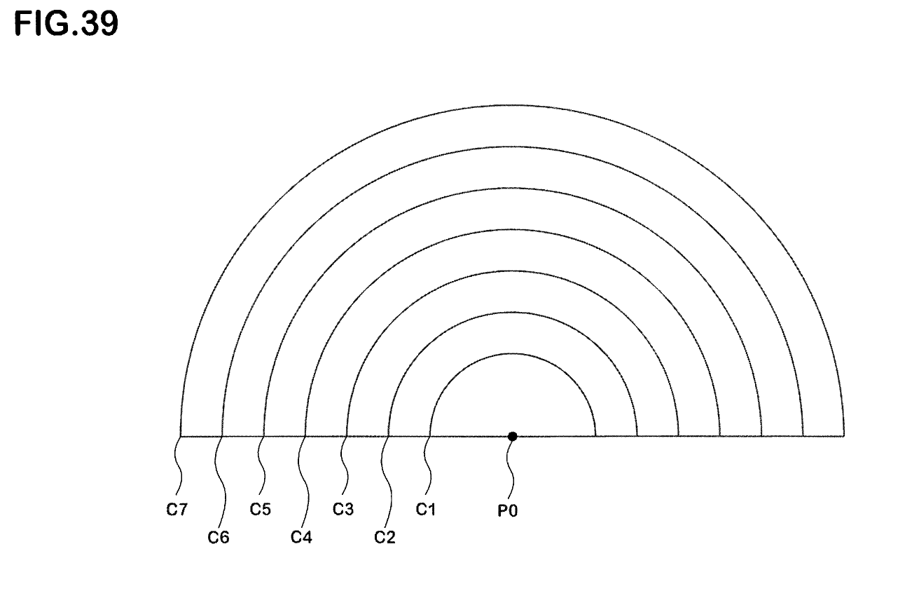

Subsequently, the CPU 120 defines septuplicate concentric circles with an equal distance (step S103). In this embodiment, it defines a reference arc C1 having a half of the radius for that of the outer most arc C7 and divides the space between the reference arc C1 and the arc C7 into 5 equal spaces and defines a total of 5 arcs such as arcs C2 through C6 and thus a total of 7 concentric circles are defined as shown in FIG. 39.

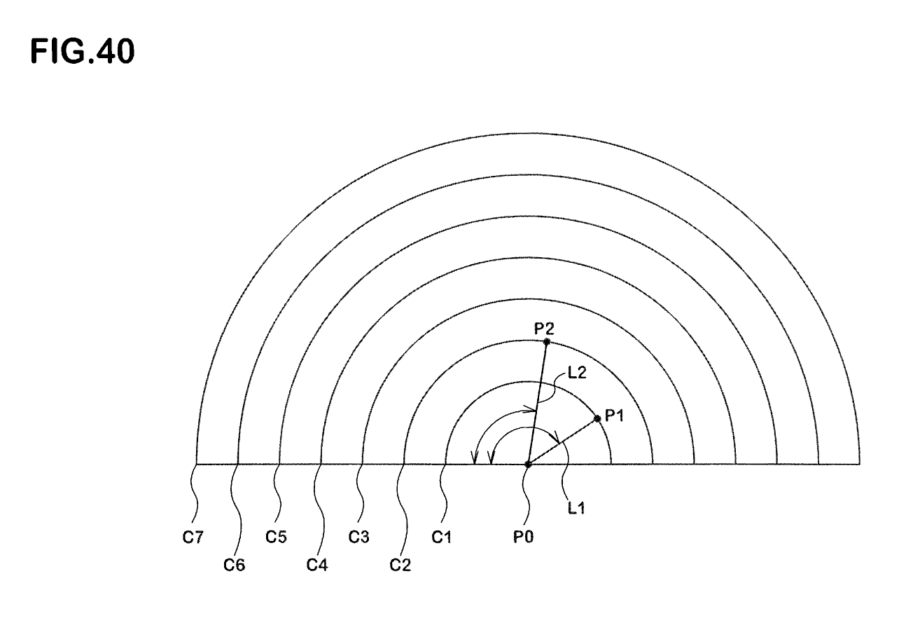

Subsequently, the CPU 120 initializes processing number k (step S105 of FIG. 38). The CPU 120 calculates an intersection pk of the kth straight line and the kth arc (step S107). In this case, another intersection p1 of a straight line L1 and an arc C1 is calculated because k equal 1. Next, the CPU 120 connects a point p(k−1) to a point pk with a line segment (step S109). In this case, the CPU 120 connects a point p0 and a point p1 with a line segment because k equal 1. In this embodiment, such line segment is the same to the line L1 because the point p0 is the center of the arc (see FIG. 40).

The CPU 120 judges whether the processing number is k or not (step S111). In this case, it increments the processing number k (step S113) because the number is not the final, then it calculates an intersection pk of the kth straight line and the kth arc (step S107). In this case, an intersection p2 of the line L2 and the arc C2 is calculated because k equal 2. Subsequently, the CPU 120 connects the point p(k−1) and the point pk with a line segment (step S109). In this case, the CPU 120 connects the intersections p1 and p2 because k equal 2 (see FIG. 40). Then the CPU 120 judges whether the processing number is k or not (step S111). In this case, it increments the processing number k (step S113) because the number is not the final and repeats the processing of steps S107 through S113.

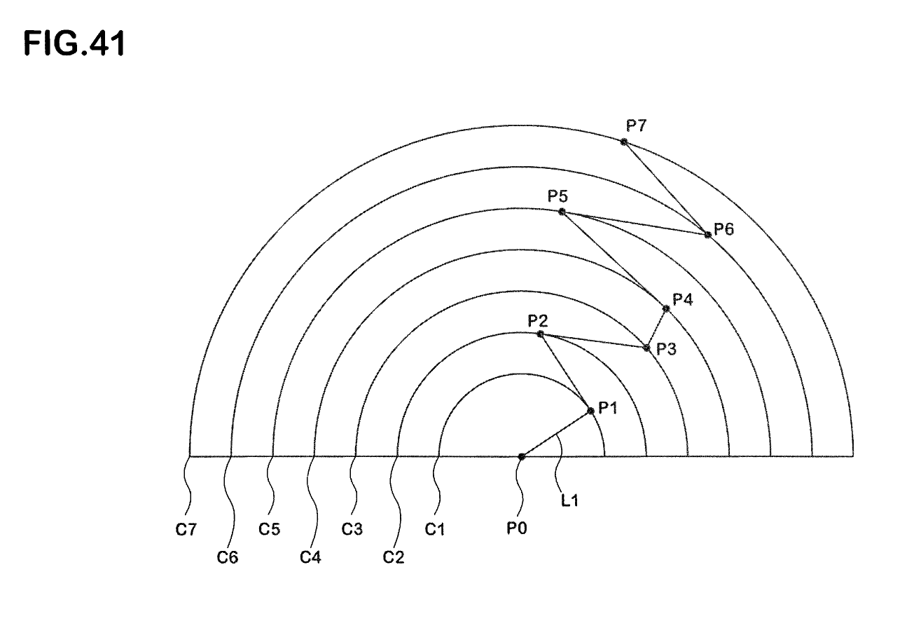

In this way, a display history similar to a line chart connecting the points p0 through p7 is generated as shown in FIG. 41. The CPU 120 transmits screen data of the generated display history to the mobile phone 58. On receipt of the data, the browsing program(s) in the mobile phone 58 displays it on the display part 56.

In this embodiment, intersections of straight lines defined by chronological data that become the base of the history data and corresponding concentric circles are calculated by defining plural number of concentric circles. In this way, the forefront of line segments can be located on arcs of the outer most ones in a predetermined number of steps without varying the angles of lines. The change of the degree in inclination of the straight lines is expressed more greatly because straight lines are defined from the origin and the intersections corresponding to arcs are calculated. It is also possible to display as history data without varying inclination of the lines.

Because the server and the mobile phone are used for constructing the system in this embodiment, it is possible to generate history display data at the server and transmit it to the terminal and on receipt of the data, the terminal displays it on its display screen.

### 4. Other Embodiments

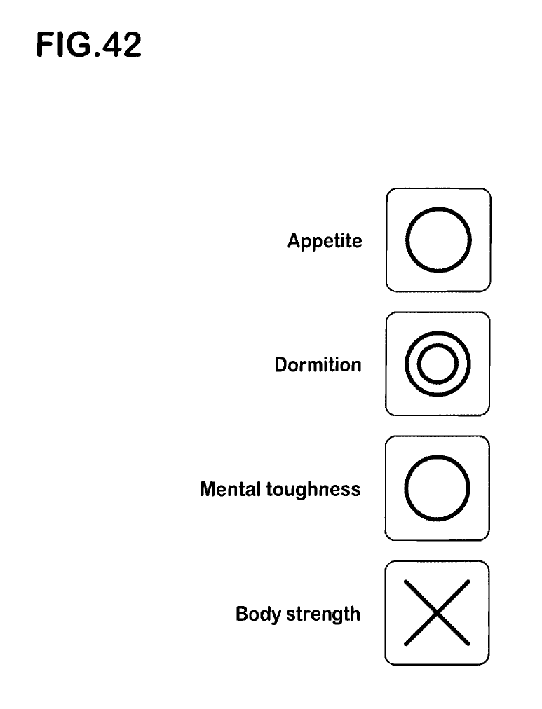

Alternatively, it is also possible to display an entry screen for entering self-judgment data of the user at that time and let the user to fill in the entry screen when the measurement of fingertip pulse waves is carried out by the user using the mouse 2. For entries “appetite”, “dormition”, “mental toughness” and “body strength” at that time, symbols such as “⊚”, “◯”, “Δ” and “X” may also selectively entered as shown in FIG. 42. During the display of history shown in FIG. 41, history data thereof may also be displayed therewith. For example, measurement for a total of 7 days, one measurement per day, is carried out, the combination shown in FIG. 42 is displayed as 7 groups. In this way, history of the self-judgment data can also be displayed.

Alternatively, the case of carrying out measurement once per day is described in this embodiment, such measurement may also be carried out plural times per day.

In this embodiment, straight lines with the angles ξ are defined using the average value of a total of 43 Lyapunov exponents as described below, in addition to the average value, standard deviations may also be calculated and displayed with them. An illustrative embodiment thereof may be carried out as described in below.

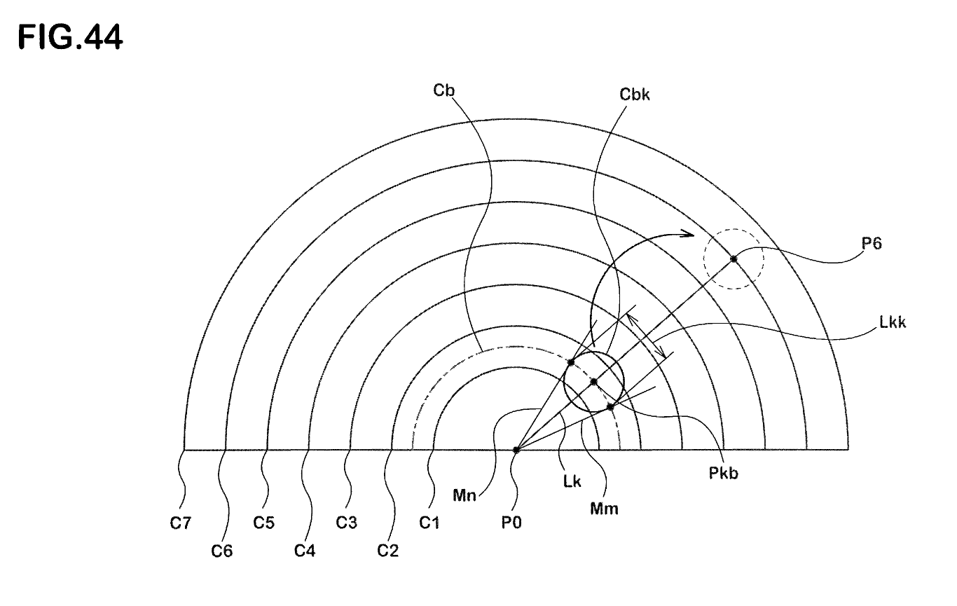

Its standard deviation sd is calculated when the average value M of the 43 Lyapunov exponents is calculated. Two straight lines Mm and Mn are defined by carrying out steps of calculating a value adding the standard deviation sd to the average value M and calculating a value subtracting the standard deviation sd from the average value M (see FIG. 44) and converting the values into angles similar to the case using the average values. Further, the origin is the same to that of the reference circle and an arc cb for determining variation having the radius of 1.15 times of the inner most arcs is defined. Then a circle Cbk passing through the intersection of the arc cb for determining variation and the 2 straight lines and its origin being pkb is defined. The circle Cbk is moved to an intersection Pk with an arc corresponding to chronological order of the straight line Lk and the circle is displayed. In this way, variation on the straight line Lk can be displayed on the intersection Pk. For example, when K equal 6, the arc is displayed on the point P6 as shown in FIG. 44.

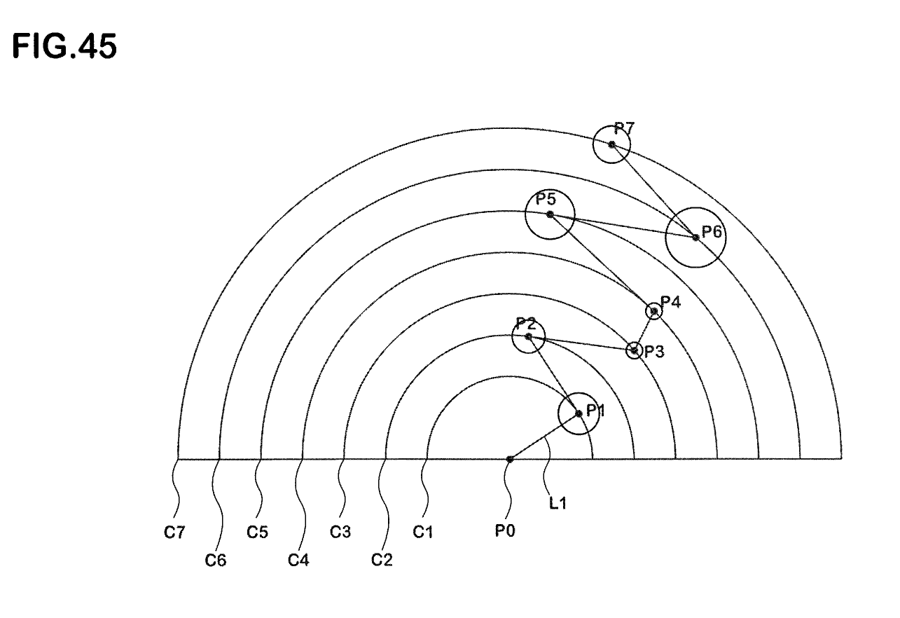

Thus, it is possible to notify variation to the user as well by displaying the circle(s) specified according to the standard deviation(s) representing variation(s). FIG. 45 shows a constellation graph displaying circles representing variations in plural measurements.

On this occasion, a circle defined by the distances between intersections of the arc for determining variation and the 2 straight lines may be displayed on any of the display means when its standard deviation sd has already been defined as 1.0.

In this way, standard deviation in each data can be notified to the operator when history is displayed with concentric circles using a constellation graph as in the present method of displaying. The steps of defining a circle Cb for notifying standard deviation, further defining two straight lines for representing variations so that the previously defined straight line is located between the two straight lines, the angles of two straight lines become larger when the degree of variations being calculated become larger, generating a circle representing variation in response to the distance between the intersections, and moving the circle to an intersection Pk corresponding to the chronological order of the line Lk, are carried out in this embodiment. In this way, standard deviation for each chronological data can be represented with the same reference circle.

Although the circle Cbk, passing through the intersection with the two straight lines Mm and Mn and making the intersection pkb as the origin thereof, is defined, but such circle may also be defined as a circle having its radius of the distance between the two straight lines Mm and Mn and its origin of the intersection pkb. No calculation for the two straight lines is required and one of the straight lines Mm and Mn may be calculated if the circle Cbk is defined as a circle passing through the intersection with the two straight lines Mm and Mn and is made the intersection pkb as the origin thereof, because the straight lines Mm and Mn are symmetry with respect to the straight line Lk. Alternatively, the circle Cbk may also be a circle that is tangent to the straight two lines Mm and Mn and is made the intersection pkb as the origin thereof.

Although, the case in which a constellation graph similar to a line chart is displayed by reading out plural number of data is described in this embodiment, it is possible to carry out the steps of defining angles of a straight line using the average value with respect to one measurement result and determining variations of the angles from the standard deviation and displaying the variations on the maximum arc of the constellation graph.

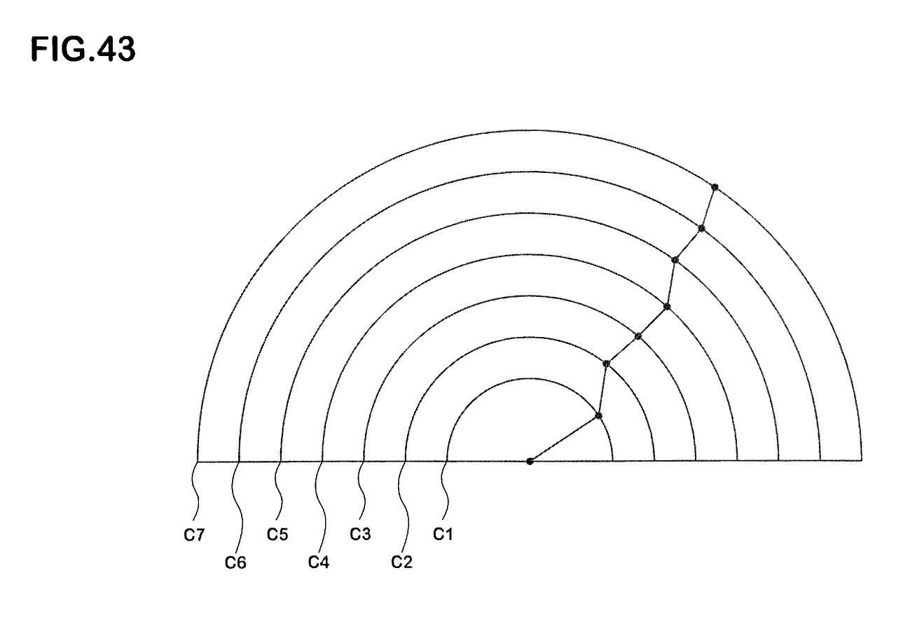

The method for displaying the straight line Lk can be varied as follows. Identical steps are carried out until the step of defining concentric circles and it is defined as a straight line with a predetermined angle passing through arc-shaped intersections most recently calculated when the subsequent straight line is defined. Then the straight line is defined as a line segment to an intersection with the subsequent arc. Even with such method, intersections can be obtained through predetermined numbers of histories on circumferential circles without varying angles. FIG. 43 shows a display example of the case in which data shown in FIG. 32 is displayed in such format.

In this embodiment, the radius of the reference arc is set to a quarter of the radius for that of the outer most arc, but it is not limited to that number and it may be of a predetermined ratio.

Although, the number of circles to be defined is determined and the same number of data to be displayed is read out in this embodiment, it is possible to determine arcs to be defined when the number of data to be displayed is specified.

In this embodiment, arcs are enlarged in the same ratio, they may be enlarged with a predetermined ratio.

The smallest arc is used as the starting arc in this embodiment, it is possible to use the outer most arcs as the starting arc.

The arcs c1 through c7 for which the intersections therewith have been calculated may be undisplayed.

Although, in the case of adopting fingertip pulse waves as measured data is described in this embodiment, it is not limited to use such pulse waves as far as displaying chronological data on a constellation graph, biological data such as blood pressures may be used therefor for example, and the method can be adopted to any other case (s) for displaying the variation in chronological data other than biological data.

In the above-described embodiments, the CPU is used for realizing each of the functions using a program(s). However, a part or entirety of the functions may also be realized with hardware such as a logic circuit and so on.

Alternatively, a part of processing of the program(s) may be performed by the operating system (OS).

The chronological data displayed on the constellation graph may also be the one without carrying out chaos analysis.

In the above disclosure, the present invention has been described as preferred embodiments, each of the terms therein is used for illustrative only and is not limitative, such terms may be amended without apart from the scope of the invention being limited solely by the claims appended hereto.

1. A history display method for displaying history of data to be displayed in a constellation graph by displaying a line segment from a center of an arc to a specific position on the arc with an angle corresponding to a value of the data to be displayed, the system comprising:
a step for storing plural data to be displayed in chronological order;
an arc definition step for defining a predetermined number of concentric arcs being enlarges for a predetermined interval from a reference arc having a predetermined diameter;
a straight line definition step for defining plural straight lines passing through a center of the reference arc and with angles corresponding to the data to be displayed in ascending order by reading out the plural number of data to be displayed from the storage means in chronological ascending order;
an intersection calculation step for calculating plural number of intersections for a straight line of a pth order out of the defined ascending straight lines and a concentric arc of the pth order from the reference arc while varying the number representing the order p; and
a connection display step for connecting the plural intersections calculated by the intersection calculation means with a line segment in chronological order and displaying the line segment;
wherein the data to be displayed is respectively constructed of data for plural measurement results,
wherein the straight line definition step, two straight lines for representing variations so that the previously defined straight line is located between the two straight line, the angles of two straight lines becoming larger when the degree of variations being calculated become larger while defining angle of the straight line from an average value of the data for plural measurement results with respect to each of the data to be displayed,
wherein the method further comprises variation representation circle definition means for calculating an intersection of a second reference arc having a radius of a predetermined ratio of the reference arc and the straight line defining two straight lines for representing variations with respect to each of the data to be displayed and for defining a circle representing variation defined in accordance with the intersection of the arc and the straight line,
and wherein in the connection display step, a circle representing variation defined by the variation representation circle definition means on a corresponding intersection.

2.-11. (canceled)

12. The history display method according to claim 1, wherein in the connection display step, also the arcs used to calculate the intersections is displayed.

13. The history display step according to claim 12, further comprising:
detection step for detecting each of the data to be displayed from a user; and
entry step for entering self-judgment data of the user at that time when the data to be displayed is detected, and
wherein in the connection display step, also the self-judgment data together with the line segment connected in chronological order is displayed.

14. A history display method for displaying history of data to be displayed in a constellation graph by displaying a line segment from a center of an arc to a specific position on the arc with an angle corresponding to a value of the data to be displayed, the method comprising:
a step for storing plural data to be displayed in chronological order;
a step for defining a predetermined number of concentric arcs each having a larger diameter than that of adjacent arc for a predetermined interval from a reference arc having a predetermined diameter;
a first intersection calculation step for calculating an intersection of a straight line and the reference arc by reading out a first ranked data to be displayed in chronological ascending order out of the plural data to be displayed, wherein the straight line pass through the center of the reference arc and is defined with an angle corresponding to each of data to be displayed;
a subsequently ranked intersection calculation step for calculating another intersection with another arc having a subsequently larger diameter than the arc used to calculate the intersection as a subsequently ranked intersection by reading out subsequently ranked data to be displayed to the data used for calculating most recently calculated intersection, wherein the another intersection pass through the most recently calculated intersection, and wherein in the calculation step, repeatedly the subsequently ranked intersection id calculated; and
a connection display step for connecting the intersection calculated in the first intersection calculation step from the center of the reference arc and the plural subsequently ranked intersections calculated in the subsequent order intersection calculation step with a line segment in chronological order and for displaying the line segment.

15. The history display method according to claim 14, wherein in the connection display step, also the arcs used to calculate the intersections is displayed.

16. The history display step according to claim 15, further comprising:
detection step for detecting each of the data to be displayed from a user; and
entry step for entering self-judgment data of the user at that time when the data to be displayed is detected, and
wherein in the connection display step, also the self-judgment data together with the line segment connected in chronological order is displayed.
